(19) United States
(12) Patent Application Publication
(10) Pub. No.: US 2015/0133593 A1
(43) Pub. Date: May 14, 2015

(54) NANO-ENHANCED ELASTOMERS

(71) Applicants: Kyle Ryan kissell, Manvel, TX (US); Clayton Charles Galloway, Austin, TX (US)

(72) Inventors: Kyle Ryan kissell, Manvel, TX (US); Clayton Charles Galloway, Austin, TX (US)

(21) Appl. No.: 13/261,989

(22) PCT Filed: Dec. 7, 2012
(86) PCT No.: PCT/GB2012/053051

§ 371 Date: Nov. 17, 2014

Related U.S. Application Data
(60) Provisional application No. 61/630,301, filed on Dec. 8, 2011.

(51) Int. Cl. C08K 7/24; C08K 3/04

(52) U.S. Cl. CPC C08K 7/24; C08K 3/04
USPC 524/496; 524/566

(57) ABSTRACT

Nanomaterial-enhanced elastomers, methods for making them, and articles made with them.

### FIELD OF THE INVENTION

The present invention is directed to: nanomaterial-enhanced elastomers; in certain particular aspects to elastomers enhanced with carbon nanotubes; and, in certain particular aspects, to articles made with a nano-enhanced elastomer or elastomers.

### BACKGROUND TO THE INVENTION

There is a wide variety of known elastomers, nanotubes, carbon nanotubes, and nano-enhanced composite materials and methods to make them.

U.S. Patent Application 2009/0030090 (Krishnamoorti et al., Ser. No. 11/659,407 filed Aug. 2, 2005) discloses carbon nanotube (CNT)/polymer composites, or “nanocomposites,” in which the CNTs in the nanocomposites are highly dispersed in a polymer matrix, and the nanocomposites have a compatibilizing surfactant that interacts with both the CNTs and the polymer matrix. Methods of making the nanocomposites are disclosed in some of which the compatibilizing surfactant provides initial CNT dispersion and subsequent mixing with a polymer. Surfactants are used with chemical groups that are able to establish strong attractive interactions with both the CNTs and with the polymer matrix, to establish polymer nanocomposites using these materials in small amounts. U.S. The nanocomposites disclosed in Krishnamoorti are used for drug delivery, scaffolding to promote cellular tissue growth and repair, fiber applications, bulk applications, ablation resistant applications, automobile applications, high temperature/high pressure applications, and combinations thereof.

### SUMMARY OF THE INVENTION

Embodiments of the invention relate to nanomaterial-enhanced elastomers; methods for making them; and articles made from them.

The present invention, in some embodiments, provides carbon nanotube (CNT)/elastomer composites, “elastomeric nanocomposites” or “composites” in which CNTs are well dispersed in an elastomer matrix including a strengthener, linking agent, or compatibilizing surfactant (“strengtheners”) that connect to, link with, or interact with both the CNTs and the elastomer matrix. The present invention is also discloses articles, such as, but not limited to, armour made with or from these composites. Desirably, the chosen strengthener interacts simultaneously with both the nanotube and with the elastomer matrix, part of the strengthener connecting to the nanotube and part to the elastomer. Certain strengtheners enable load transfer from the elastomer to the nanotubes. This load transfer may be one, two or three of the following: mechanical load transfer, thermal transfer, and electrical transfer.

In some embodiments, functionalized carbon nanotubes are used in the composites according to the present invention. In certain particular aspects, the carbon nanotubes are functionalized with a strengthener, e.g. a surfactant, which simultaneously provides: (a) dispersion within an elastomer/solvent emulsion and the coagulated (solidified) elastomer; and (b) a linking agent between the nanotube and the elastomer backbone. Suitable strengtheners interact both with the nanotubes and with an elastomer to enable load transfer from the elastomer to the nanotubes (e.g., one, two or three of mechanical load transfer, thermal transfer, and electrical transfer) and such strengtheners include, but are not limited to, certain zwitterionic surfactants that accomplish these two functions. The strengthener, in certain aspects, has a backbone that bonds to the nanotube (e.g. through hydrogen bonding and hydrophobic forces) and a head group that bonds to the elastomer backbone (e.g. through hydrogen bonding primarily). This enables mechanical load (stress) transfer from the elastomeric material to the considerably stronger nanotube.

In certain embodiments, multi-walled carbon nanotubes (MWNTs) are dispersed in an elastomer with the aid of a suitable surfactant, e.g., a zwitterionic surfactant, e.g. (12-aminododecanoic acid (“ADA”)(see, for example, the elastomer of FIG. 14A) or amino lauric acid, as a compatibilizer. In other aspects, a suitable strengthener is a functionalized nanotube, e.g., a nanotube with a chemically covalently functionalization, e.g., a nanotube functionalized with fluorine (see, e.g., the elastomner of FIG. 21A).

In certain aspects, an enhanced composite according to the present invention has a low concentration of carbon nanotubes; e.g., between 1% and 10% by weight. In certain aspect, any suitable known additive or known additive package is used with the elastomer. In certain aspects, the additives used are carbon black, antioxidants, and curing agents. In one aspect, the components and additives are as follows: 100 phr (parts per hundred) elastomer, e.g. HNBR (e.g., either one grade or a combination of two grades of HNBR to achieve a desired viscosity and ACN content); approximately 40 phr total carbon black (e.g., a single source/grade or multiple grades); 5 phr antioxidants (e.g., one or a variety of oxidation inhibitors); and approximately 5 phr curing agent (e.g., peroxide or sulphur based). Additives may also include plasticizers, barrier molecules (e.g., to prevent fluid swell or fluid penetration), viscosity modifiers, lubricity modifiers, and simple volume fillers.

The elastomer may be any elastomer and, in certain aspects, the elastomer is: nitrile butadiene rubber (referred to as natural rubber or “NBR”), e.g., but not limited to, NIPOL (trademark) NBRs; hydrogenated butadiene nitrile rubber (“HNBR”), e.g., but not limited to, ZETPOL (Trademark) HNBRs; a fluoroelastomers, e.g. VITON (Trademark) fluoroelastomers and FKM (Trademark) material; or elastomeric polyurethane—or a combination of these. In other aspects, the elastomer is one of, or a combination of, the elastomers mentioned above or is one of, or a combination of, these elastomers: saturated rubbers that cannot be cured by sulphur vulcanization; unsaturated rubbers that can (or cannot) be cured by sulphur vulcanization; thermoplastic elastomers; polysulfide rubber; proteins resilin and elastin; and dielectric elastomers.

Unsaturated rubbers that can (or cannot) be cured by sulphur vulcanization usable as the elastomer in embodiments of the present invention can include, for example, natural polyisoprene cis-1,4-polyisoprene natural rubber and trans-1,4-polyisoprene gutta-percha; synthetic polyisoprene (IR, isoprene rubber); polybutadiene (butadiene rubber); chloropene rubber (CR), polychloropene, Neoprene, Baypren, etc.; butyl rubber (copolymer of isobutylene and isoprene, IIR; halogenated butyl rubbers (chloro butyl rubber: CIIR; bromo butyl rubber: BIIR); styrene-butadiene rubber (copolymer of styrene and butadiene); nitrile rubber (copolymer of butadiene and acrylonitrile, NBR) also called Buna N rubbers; and hydrogenated nitrile rubbers (HNBR), Therban and Zetpol.

Saturated rubbers that cannot be cured by sulphur vulcanization usable in embodiments of the present invention include, for example: EPM (ethylene propylene rubber, a copolymer of ethylene and propylene) and EDPM rubber (ethylene propylene diene rubber, a terpolymer of ethylene, propylene and a diene-component); epichlorohydrin rubber (ECO); Polyacrylic rubber (ACM, ABR); silicone rubbber (SI, Q, VMQ); Fluorosilicone Rubber (FVMQ) ; fluroelastomers (FKM and FEPM), Viton, Tecnoflon, Fluorel, Aflas and Dai-El; perfluoroelastomers (FFKM), Tecnoflon, PFR, Kalrez, Chemraz, Perlast; polyether block amides (PEBA); Chlorosulfonated polyethylene (CSM), (Hypalon); and ehtylene-vijnyl-acetate (EVA).

Thermoplastic elastomers (TPE), sometimes referred to as thermoplastic rubbers, usable in some embodiments of the present invention include materials with both thermoplastic and elastomeric properties. Thermoplastic elastomers, sometimes referred to as thermoplastic rubbers, usable in some embodiments of the present invention include: styrenic block copolymers, polyolefin blends, elastomeric alloys (TPE-v or TPV), thermoplastic polyurethanes, thermoplastic copolyester and thermoplastic polyamides, Arnitel (DSM), Engage (Dow Chemical), Hytrel (DuPont), Kraton (Shell Chemicals), Pebax (Arkema), Pellethane, Riteflex (Ticona), Styroflex (BASF); and commercial products of elastomer alloy, e.g., but not limited to, Alcryn (Du Pont), Dryflex, Evoprene (AlphaGary), Forprene, Geolast (Monsanto), Mediprene, Santoprene and Sarlink (DSM).

In certain aspects, the present invention provides dielectric elastomers and dielectric elastomer actuators. Dielectric elastomers (DEs) are smart material systems which produce strains and are, in certain aspects, electroactive polymers (EAP). Dielectric elastomer actuators (DEA) made with an elastomer or with elastomers according to the present invention transform electric energy directly into mechanical work. In certain aspects, the elastomer according to the present invention is nano-enhanced silicone or acrylic elastomer.

In certain dielectric actuators according to the present invention, an elastomeric film (which may include nano-enhanced elastomer or elastomers according to the present invention) is coated on both sides with electrodes (which may include electrically-conducting nanomaterial). The electrodes are connected to a circuit and voltage is applied resulting in electrostatic pressure. Due to mechanical compression the elastomer film contracts in the thickness direction and expands in the film plane directions. The elastomer film moves back to its original position when it is short-circuited. The dielectric actuators according to the present invention may be framed/in-plane actuators; cylindrical/roll actuators; diaphragm actuators; shell-like actuators; stack actuators; and thickness mode actuators.

In certain aspects, the elastomer used in a composite according to the present invention is peroxide-cured HNBR or peroxide-cured VITON (Trademark) elastomer. In other aspects, the elastomer used in a composite according to the present invention is sulphur-cured NBR.

In certain aspects, the functionalization for the nanotubes is one that: enables nanotube dispersion in an elastomer/solvent emulsion and the elastomer itself after it is coagulated (solidified); provides attachment to the elastomer that interacts with the elastomer backbone in such a way that mechanical, thermal, and/or electrical load can be transferred; attachment to the nanotube sufficiently robust so that mechanical, thermal, and/or electrical load is transferred to the nanotube; and a functionalization that does not fully treat (react, cure, vulcanize) the elastomer so that undesirable brittleness is produced which would deleteriously decrease elastomer elongation. One type of bonding that enables mechanical load transfer without sacrificing elongation is non-covalent hydrogen bonding. Such bonding and/or attachment can provide effective mechanical load transfer, thermal transfer and/or electrical transfer.

### BRIEF DESCRIPTION OF THE DRAWINGS

How the invention may be put into effect will now be described, by way of illustration only, with reference to the accompanying drawings, in which like elements are identified by like reference numerals, and:

FIG. 1 is a schematic perspective view of a composite according to the invention;

FIG. 2 is a side view of the composite of FIG. 1;

FIGS. 3A and 3B are is a cross-sectional views of backings, and FIG. 3C is a side view of a backing;

FIG. 4A is a a cross-sectional view of armour, FIG. 4B is a top view of the armour of FIG. 4A and FIG. 4C is a cross-sectional view of armour,

FIG. 5A-5C are cross-sectional views of armour and FIGS. 5D, 5E and 5F are top views of armour,

FIGS. 6A and 6B are perspective partially cut-away views of armour,

FIGS. 7A-7D are cross-sectional views of armour,

FIG. 8 is a perspective exploded view of armour,

FIG. 9 is a cross-sectional view of armour,

FIG. 10 is a perspective partially cross-sectional view of armour,

FIG. 11 is a cross-sectional view of armour and

FIG. 12A is a front view of an armour vest; according to the present invention.

FIG. 12B is a front view of a tile;

FIG. 12C is a cross-section view of material according to the present invention used to make a tile as in FIG. 12B;

FIG. 13 is a schematic view of an article;

FIGS. 13A-13G are respectively perspective views of a tile, a disc, a panel, a cylinder, a pyramid, a sphere and a cone, FIG. 13H is a side view of a knife according to the present invention, FIGS. 13I-13M are respectively side views of a key, a gear, a hook, a nut-bolt combination and a chain, FIG. 13N is a top view of a chain, FIGS. 13O and P are respectively side views of a screw and a scalpel, FIG. 13Q is a cross-sectional view of a bearing structure, FIGS. 13R-13T are respectively side views of a drill bit, a mill and a reamer and FIG. 13U is a perspective view of a pipe;

FIG. 14A is an SEM image of a nanoenhanced elastomer, FIG. 14B is an enlargement of a portion of the image of FIG. 14A,

FIG. 15A is a TEM image showing nanotubes in an elastomer as in the elastomer of FIG. 14A, FIG. 15B is a TEM image showing nanotubes in an elastomer as in the elastomer of FIG. 14A and FIGS. 15C-15F are TEM images showing nanotubes in an elastomer as in the elastomer of FIG. 14A;

FIG. 16 presents dynamic mechanical analysis (DMA) storage modulus data graphically for the elastomer of FIG. 14A;

FIGS. 17-19 and 20A-20C respectively present data in tabular form for tensile properties, oil resistance properties, tensile properties, carbon dioxide explosive decompression properties, compression set properties and thermal conductivity properties of the elastomer according to the present invention of FIG. 14A;

FIGS. 21A and 21B present data comparing a known elastomer to nano-enhanced elastomers according to the present invention;

FIG. 22 is an end view of a shale shaker,

FIG. 23 is a side view of a vibratory apparatus,

FIG. 24 is a perspective view of a vibratory separator,

FIG. 25 is an end view of a shale shaker,

FIG. 26A is a top view of a structural member, FIG. 26B is a side cross-section view of the member of FIG. 26A,

FIGS. 27-29 are side cross-section views of a member;

FIG. 30A is a side-sectional view of an underwater vehicle with a vibration and acoustic insulating device according to the present invention, FIG. 30B is a cross-sectional view of the vibration and acoustic insulating device as in FIG. 30A mounted to a vehicle hull and FIG. 30C is a perspective cross-sectional view of a structure having a vibration and acoustic insulating device; and

FIG. 31 is an end view of a stiffener with a constrained layer damping system,

FIG. 32 is an end view of a stiffener with a constrained layer damping system and FIG. 33 is a cross-sectional view of a damping panel.

### DETAILED DESCRIPTION OF PREFERRED EMBODIMENTS

Carbon nanotube (CNT)/elastomer composites, referred to herein as “nanocomposites,” are provided wherein the CNTs are dispersed in an elastomer matrix, and wherein the nanocomposites include a compatibilizing surfactant that interacts with both the CNTs and the elastomer matrix. Methods of making these nanocomposites, and articles using these nanocomposites in a variety of applications are also provided.

Carbon nanotubes (CNTs) include, but are not limited to, single-wall carbon nanotubes (SWNTs), multi-wall carbon nanotubes (MWNTs), double-wall carbon nanotubes (DWNTs), buckytubes, small-diameter carbon nanotubes, fullerene tubes, tubular fullerenes, graphite fibrils, carbon nanofibers, and combinations thereof. Such carbon nanotubes can be of a variety and range of lengths, diameters, number of tube walls, chiralities (helicities), etc., and can be made by any known technique including, but not limited to, arc discharge (Ebbesen, Annu. Rev. Mater. Sci. 1994, 24, 235-264), laser oven (Thess et al., Science 1996, 273, 483-487), flame synthesis (Vander Wal et al., Chem. Phys. Lett. 2001, 349, 178-184), chemical vapor deposition (U.S. Pat. No. 5,374,415), wherein a supported (Hafner et al., Chem. Phys. Lett. 1998, 296, 195-202) or an unsupported (Cheng et al., Chem. Phys. Lett. 1998, 289, 602-610; Nikolaev et al., Chem. Phys. Lett. 1999, 313, 91-97) metal catalyst may also be used, and combinations thereof. Depending on the embodiment, the CNTs can be subjected to one or more processing steps. In some embodiments, the CNTs have been purified. Exemplary purification techniques include, but are not limited to, those by Chiang et al. (Chiang et al., J. Phys. Chem. B 2001, 105, 1157-1161; Chiang et al., J. Phys. Chem. B 2001, 105, 8297-8301). In some embodiments, the CNTs have been cut by a cutting process. See, e.g., Liu et al., Science 1998, 280, 1253-1256; and Gu et al., Nano Lett. 2002, 2(9), 1009-1013. The nanotubes may be functionalized using any known functionalization. In certain aspects, the functionalization is non-covalent surfactant wrapping with a zwitterionic surfactant which simultaneously interacts with the elastomer backbone and the nanotube to enable mechanical load transfer between the two materials.

In referring to CNTs dispersed in a liquid solvent, the terms “solution” and “dispersion” are used interchangeably, unless otherwise indicated. Such solutions are typically not true solutions in the thermodynamic sense. Additionally, the term “dispersion” is also used herein to refer to the degree to which CNTs are dispersed in a polymer matrix in a polymer nanocomposite of the present invention.

In some embodiments, the present invention discloses elastomeric nanocomposites including: (a) CNTs; (b) an elastomer matrix in which the CNTs are dispersed; and (c) a compatibilizing surfactant, wherein said surfactant interacts with both the CNTs and the elastomer matrix. Such interactions include, but are not limited to, ionic bonding, covalent bonding, electrostatic interactions, hydrogen bonding, hydrophilic/hydrophobic forces, and the like. One, two, or three types of load transfer may be accomplished by these “interactions” according to the present invention.

Mechanical load transfer is generally defined as the imparting of force from one object or material to another. Mechanical load transfer typically occurs between a relatively weak material (such as an elastomer) and a relatively strong material (such as a carbon nanotube) to create a “composite”. A typical example of “materials” load transfer is “rebar” reinforced concrete. The rebar/concrete “composite” is stronger than unreinforced concrete because force can be imparted from the relatively weak concrete to the relatively strong steel. Mechanical load transfer encompasses forces such as tensile, modulus, stress, radial, and bending loads. Thermal or heat transfer is the exchange of thermal energy (heat) between one physical system and another. Thermal transfer can occur either between a high temperature region and a low temperature region or between a relatively poor thermal conductor (such as an elastomer) and a relatively good thermal conductor (such as a carbon nanotube). Electrical transfer is the transfer of electrical energy (electrons or “electric current” between one physical system and another. Electrical transfer either occurs between a highly charged region and a poorly charged region or between a relatively poor electrical conductor (such as an elastomer) and a relatively good electrical conductor (such as a carbon nanotube. Certain elastomer/CNT composites according to the present invention exhibit good mechanical load transfer, some improvement in thermal transfer, and little change in electrical performance.

In some such embodiments, such CNTs include purified CNTs, unpurified CNTs (raw, as-produced), and combinations thereof. In some such embodiments, the CNTs are selected from the group including SWNTs, MWNTs, carbon nanofibers, and combinations thereof (see above). In certain aspects, the amount of such CNTs in the elastomer nanocomposites ranges from about 0.0001 wt. % to about 90 wt. %; in other aspects, the amount of CNTs is relatively low, i.e., 4 wt. %.

In some embodiments, some, all, or at least some of the CNTs are functionalized in a manner selected from the group consisting of sidewall functionalization and end functionalization, and combinations thereof (Chen et al., Science, 1998, 282, 95-98; Khabashesku et al., Acc. Chem. Res., 2002, 35, 1087-1095; and Bahr et al., J. Mater. Chem., 2002, 12, 1952-1958). The amount of functionalized CNTs can range from about 0.0001 wt % to about 90 wt % of the weight of the resulting nanocomposite.

The elastomer can be any elastomer(s) or combination thereof can be any that suitably interacts with a surfactant that, in turn, interacts with the CNTs.

The surfactant can be any surfactant that suitably interacts with both the CNTs and the elastomer matrix in the elastomer nanocomposite (e.g., a zwitterionic surfactant). In certain embodiments, the surfactant is present in the nanocomposite in an amount ranging from about 10⁻⁶ wt % to about 15 wt %.

In some embodiments, the mixing is carried out in a solvent. In some such embodiments, the solvent is removed after mixing via vacuum drying, via heating, or via coagulation into a second solvent in which the elastomer is insoluble. In some embodiments, the resulting nanocomposite is isolated by precipitation in a non-solvent followed by drying. In some embodiments, the mixing is carried out in an apparatus; e.g., a blending apparatus; single-screw extruder; twin screw extruder; and injection molder. In some embodiments, the mixing is used to prepare a masterbatch followed by drawdown to necessary composition. In some embodiments, the mixing is carried out at a temperature of from about −100° C. to about 400° C.

In one embodiment, for example, elastomer is dissolved in acetone, approximately 16% solids (elastomer), producing a “cement”. Carbon nanotubes are dispersed in additional acetone and are then added to the elastomer cement, decreasing the wt % solids to about 8%. The mixture is then poured into methanol or water to harvest the nanotubes/elastomer mixture. The elastomer coagulates or solidifies (matrix) and the nanotubes become incorporated into the matrix during this process. The coagulated nanotube/elastomer is removed from the methanol/acetone and dried to remove excess solvent. The methanol/acetone solution is transmitted for further processing, e.g., fractionation or recycling.

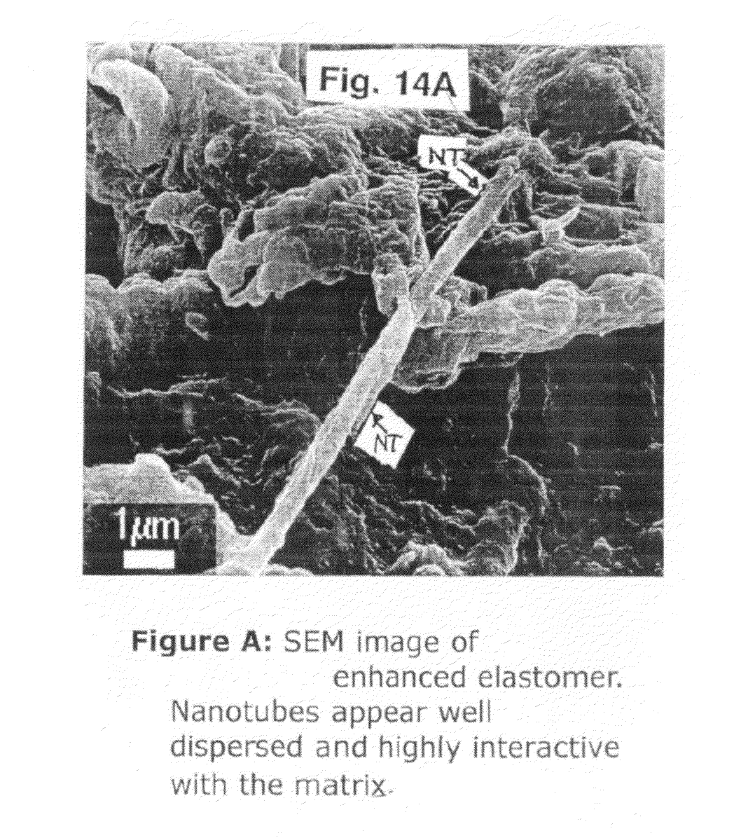

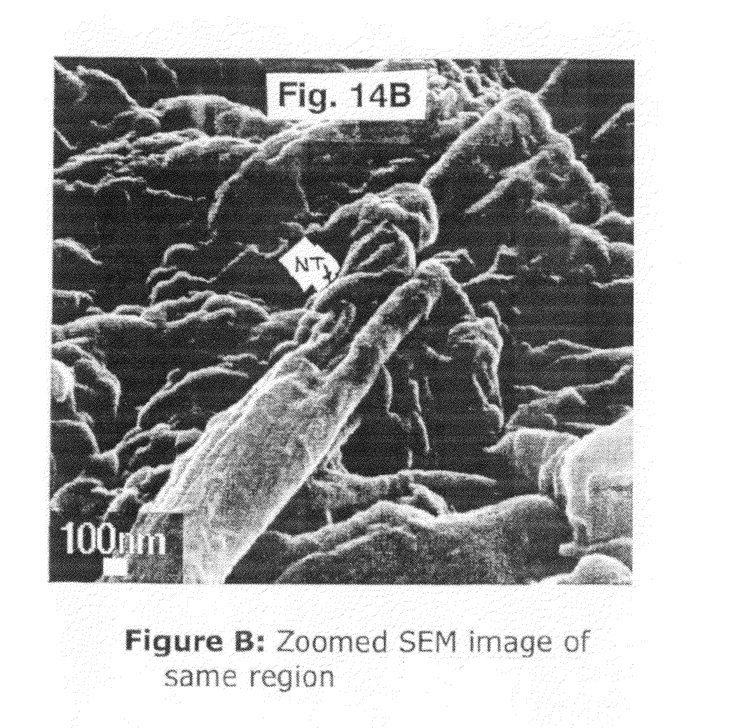

In one particular embodiment, (see the elastomer as shown in FIGS. 14A and 14B) functionalized carbon nanotubes (small-diameter multi-walled carbon nanotubes—10-15 nanometer diameter, functionalized with fluorine) are dispersed in a low viscosity solvent, acetone, and suspended in the acetone by sonication. They were then added to an elastomer/acetone matrix (elastomer: HNBR) by high shear and paddle mixing. The specific HNBR used was commercially available ZETPOL (Trademark) 1020 elastomer which did not degrade during processing. Optionally, a mixture of two different grades of HNBR may be used (e.g., two or more ZETPOL (trademark) material grades are mixed—e.g., ZETPOL 1020 and 2010L—to control acrylonitrile (ACN) content, hardness, or viscosity.

The HNBR was dried to less than 0.02% solvent (e.g., by heating in a vented oven, by pressing the material on a two or three roll mill, or by exposure to a stream of dry, hot gas) and, using a Haake high-shear mixer, was compounded with an additive package using known additives, e.g. between 30% and 60% by weight, between 40-45%, or between 10% to 15% by weight. Plaques of the resulting composite (e.g., discs 6 inches in diameter and between 2 and 3 millimeters in thickness) were cured by heat and pressure e.g. at about 177° C. for 12 minutes at 138 mPa (20,000 psi). The plaques were then post-cured in a vented oven at about 177° C. for 2.5 hours. A curing agent (e.g., either peroxide or sulphur) is activated during the original heating process and full cure is achieved through the post-curing process. The resulting composite had about 4% carbon nanotubes by weight relative to the elastomer mass.

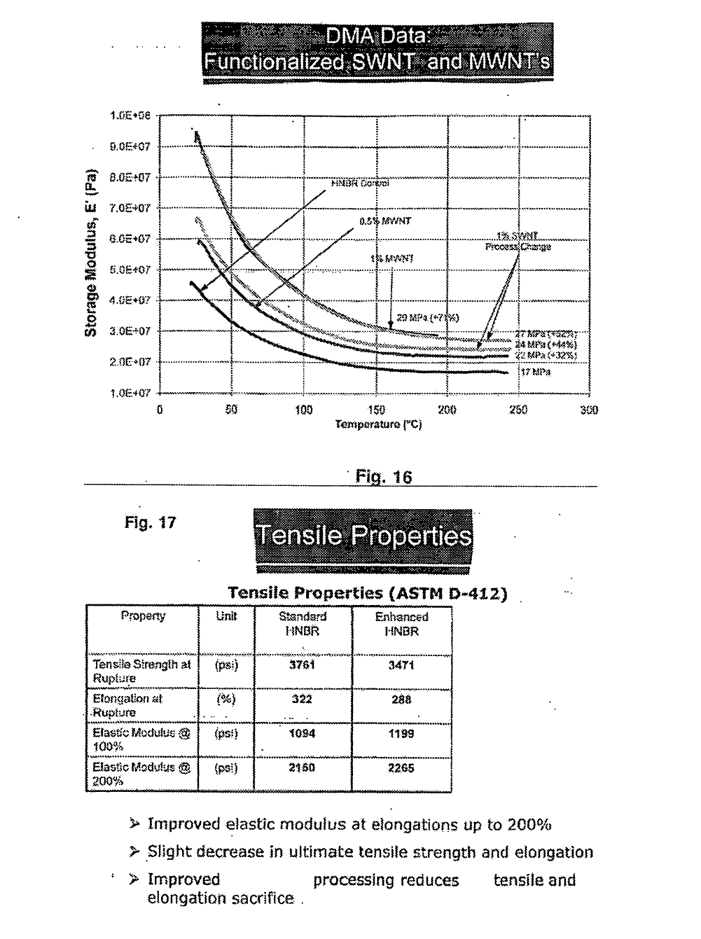

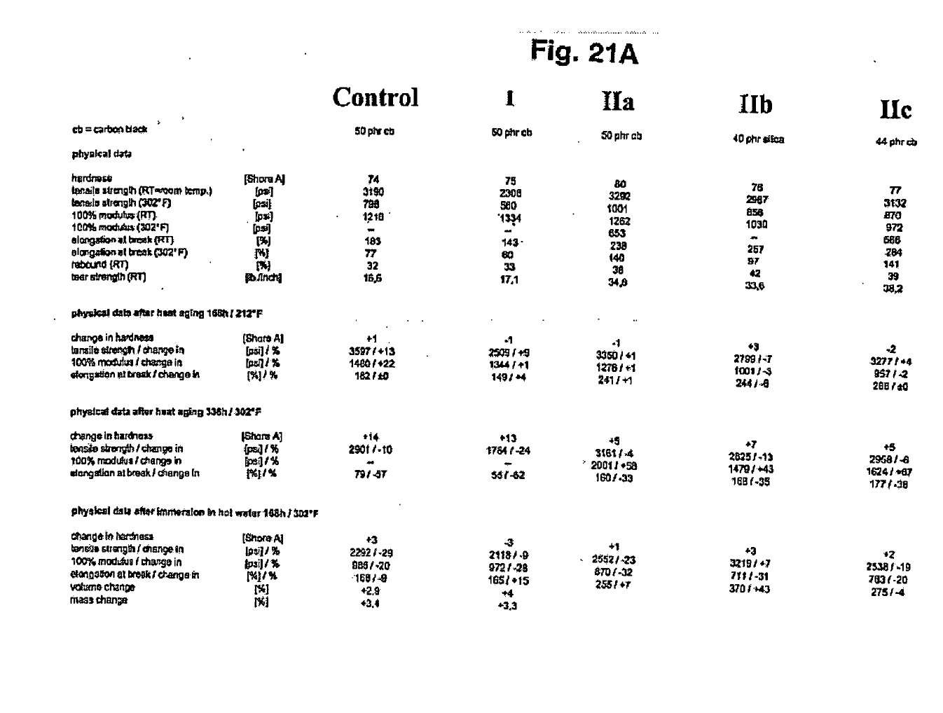

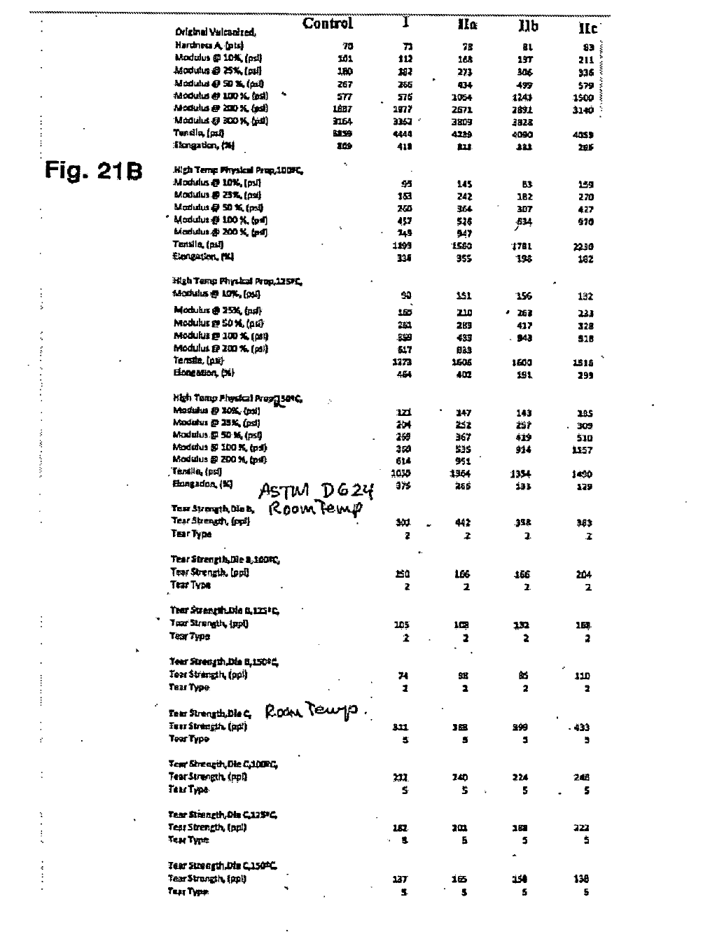

The data discussed below indicates that the resulting composite had good dispersion of carbon nanotubes, minimal or no significant adverse effects on the elastomer (rheology, hardness, scorch time, cure time, etc.), uniformity of properties and minimal or no effect on curing or curing chemistry by nanotubes. This composite had these property improvements:
elastic modulus at elongations up to 200%
diminished property degradation due to exposure to oil
improved DMA storage modulus at elevated temperatures
improved resistance to carbon dioxide explosive decompression
improved compression set
increased thermal conductivity
   The data discussed below (and also that of FIGS. 21A and 21B) is for both control material and elastomers according to the present invention that have the same additive package. With elastomers which are embodiments of the present invention, such as those for which facts and/or data is presented in FIGS. 16 and 21A and 21B, a plurality of properties (e.g. those properties listed above) are improved but with a much lower than expected sacrifice of elongation and, in some cases, of tensile strength (e.g., tensile strength at rupture before and after oil treatment, elongation before and after oil treatment).

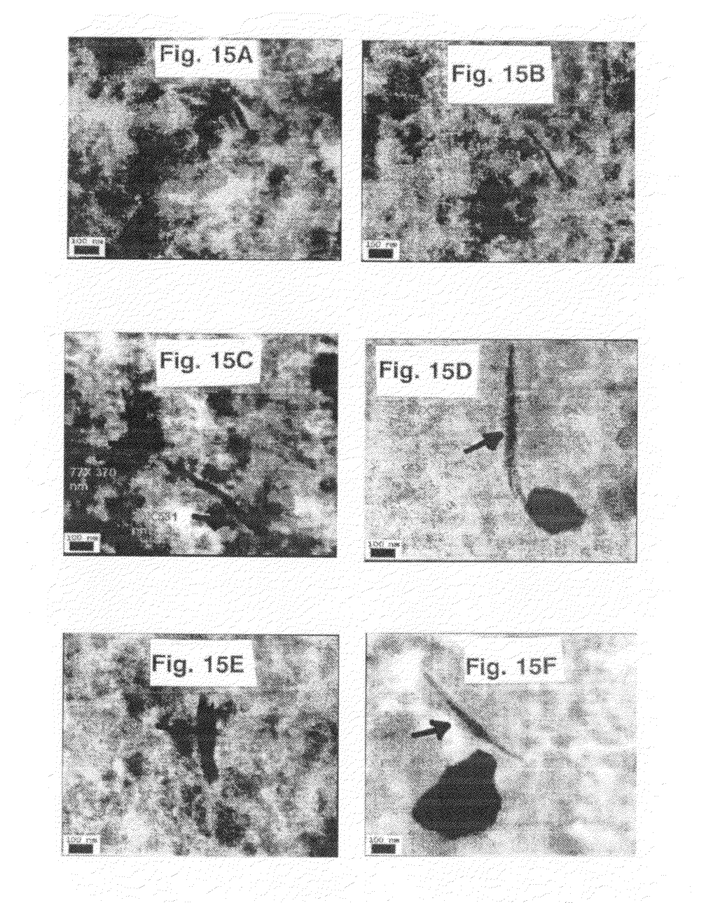

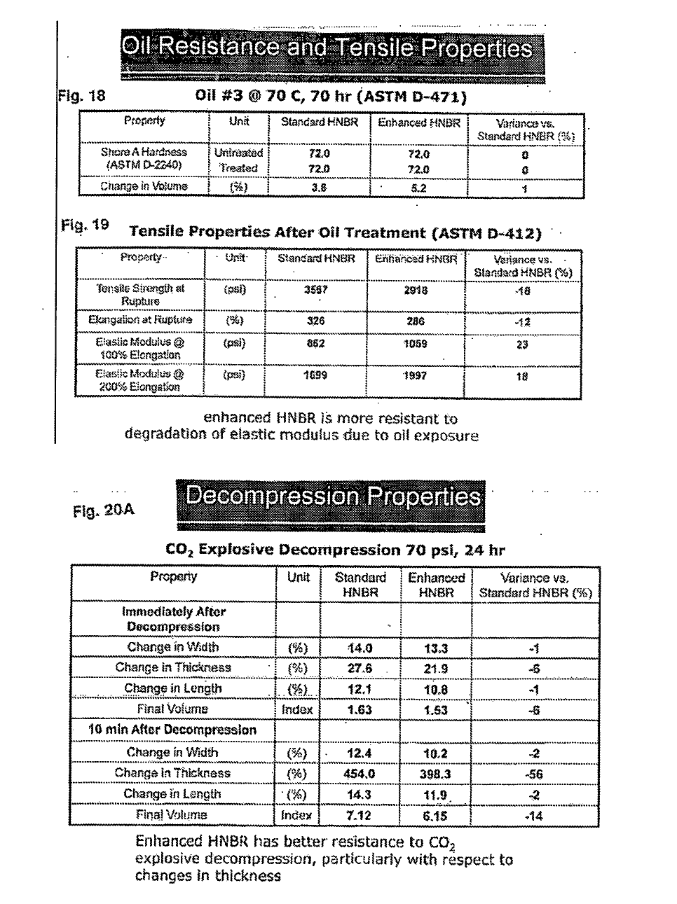

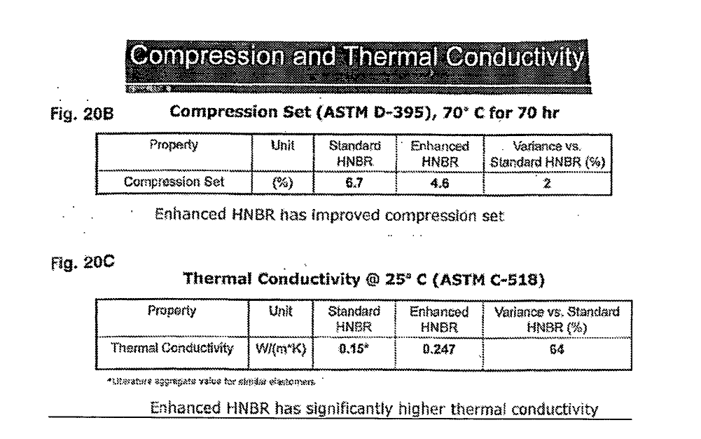

FIGS. 14A and 14b present scanning electron microscope images of the elastomer described above. These figures show elastomer-covered nanotubes NT. FIGS. 15A-15F are transmission electron microscope (TEM) images of the elastomer showing carbon nanotubes dispersed therein (arrows indicate nanotubes). FIG. 16 presents dynamic mechanical data for the elastomer of FIG. 14A. Data is presented for a control elastomer (“HNBR control”) with no nanotubes and no strengthener. Data is also presented for a nano-enhanced HNBR elastomer with 0.5 wt. % multi-walled nanotubes (small diameter multi-walled carbon nanotubes functionalized with fluorine; e.g., see FIG. 14A) and data for a nano-enhanced HNBR elastomer with 1.0 wt. % multi-walled nanotubes (small diameter multi-walled carbon nanotubes functionalized with fluorine; e.g., see FIG. 14A). Data is also presented for a nano-enhanced elastomer in which single-walled small diameter nanotubes were mixed with HNBR at relatively high input energy, high shear (“1% SWNT”). This data (in FIG. 16) illustrates, at about 240° C., a 32% increase in storage modulus for the 0.5% MWNT elastomer and a 62% increase in storage modulus for the 1% MWNT elastomer. FIG. 17 presents tensile property data for the control material (“HNBR Control”) and for an elastomer according to the present invention (“Enhanced HNBR”)—(1% MWNT functionalized with fluoroine). FIG. 18A presents oil resistance property data. FIG. 18B presents tensile property after-oil-treatment data. FIG. 19 presents dynamic mechanical data. FIG. 20 presents carbon dioxide explosive decompression data. FIG. 21 presents compression set data.

Another embodiment of an elastomer according to the present invention exhibited a storage modulus, at 30° C. of 18.3 MPa while a control elastomer which was not nano-enhanced had a storage modulus of 9.37 MPa. This particular elastomer according to the present invention was made with HNBR and a zwitterionic surfactant, amino dodecanoic acid which surfactant-wrapped the nanotubes (small diameter, 10-15 nm, carbon MWNTs), about 96 wt % HNBR and about 4 wt% MWNTs. The Loss Modulus for this nano-enhanced elastomer was 1.73 at 30° C. and the control had a Loss Modulus of 0.989.

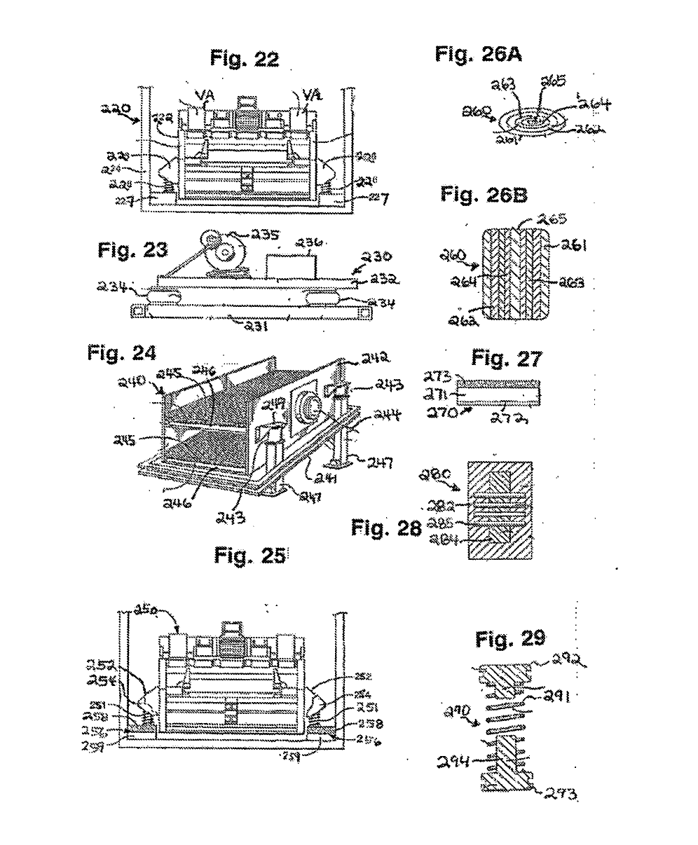

Data relating to physical properties of an elastomer according to the present invention is presented in FIGS. 21A and 21B (and for a control material, both with the same additive package). Nanoenhanced elastomers according to the present invention include I (like that of FIG. 14A); and IIa, IIb, and IIc made with the surfactant as described in the paragraph above. The Control, I and IIa had 50 phr carbon black (phr is pats per hundred). IIb had 40 phr silica and IIc had 44 phr carbon black. In FIG. 21B, “Modulus” is elastic modulus. This data shows, inter alia, a significant increase in modulus for the nano-enhanced elastomers (e.g. about 250% greater for IIb and about 320% greater for IIc). FIG. 22 presents thermal conductivity data (tests for data in certain of these figures are standard ASTM tests indicated with the letters “ASTM”).

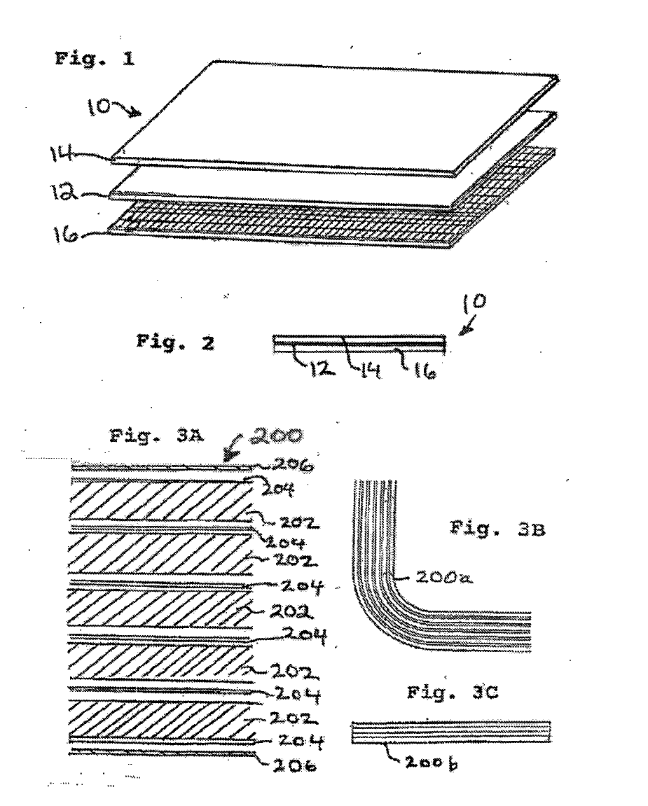

FIGS. 1 and 2 show armour 10 according to the present invention which has a binder layer 12, a first outer layer 14, and a second outer layer 16. The binder layer 12 has surfactant-wrapped nanotubes. It may be made as described above using surfactant wrapped nanotubes and any desired elastomer (e.g., but not limited to, HNBR). A resulting suspension of nanotubes in ethanol is sprayed onto a binder sheet of thermoplastic polyurethane. The sprayed sheet is dried, immobilizing the surfactant-wrapped nanotubes on the sheet. The resulting binder layer 12 is then placed between any desired number of layers of materials used in armour, e.g., ballistic fabrics, glass, fiberglass, polyethylene, polypropylene, ceramic, etc. As shown, the binder layer 12 is between a layer 14 which is about 23 mm (0.92 inches) thick; the binder layer 16 is about 0.5 mm (0.02 inches) thick. The combined layers may be subjected to heat treatment (any disclosed or referred to herein) and/or to compression (any pressure method disclosed or referred to herein). The binder 12 facilitates holding together of the layers; and the nanotubes, linked to the binder material by the surfactant, increase the shock absorption of the armour.

It is within the scope of the present invention for an armour composite according to the present invention to be: binder material (e.g., as described herein; e.g., as described in co-owned pending U.S. applications 2011/0174145 (Charles) and 2011/0177322 (Ogrin), Ser. Nos. 12/657,289 and 12/657,244, both filed 16 Jun. 2010) the contents of which are incorporated herein by reference; one or more layers of nano-enhanced elastomer as disclosed herein; one or more layers of nano-enhanced elastomer as disclosed herein between a ceramic layer and one or more fabric layers for absorbing shock; or one or more layers of nano-enhanced elastomer according to the present invention and a binder according to the present invention with nano-enhanced elastomer.

FIG. 3A shows an exploded view of a backing 200 (armour) according to the present invention (the drawing is not to scale) which includes multiple layers of ballistic fabric 202, which may be any known ballistic fabric, including, but not limited to KEVLAR (Trademark) material, ARAIVIID (Trademark) fabric material, SPECTRA SHIELD (Trademark) material, and polyethylene ballistic material. Between fabric layers 202 is a layer (or layers) 204 of binder material made, e.g. with a surfactant in a suspension and/or with a nano-enhanced elastomer according to the present invention.

In one aspect the substrate for the binder layer, the material onto which the nanotube suspension is applied, is any suitable known binder; e.g., but not limited to, a sheet of plastic, or an epoxy coating, or a spray-on adhesive.

In one aspect the binder layer 204 includes a thin film of carbon nanotubes (“buckypaper”). In one aspect, the binder 204 contains carbon nanotubes and graphene ribbon-like material. In certain aspects, the layers 204 are thermoplastic nanocomposite film (as the material in U.S. patent application 2008/0199772 (Amatucci) Ser. No. 12/025,662 filed 4 Feb. 2008) the contents of which are incorporated herein by reference.

In certain particular aspects the binder layer 204 includes a thermoplastic polyurethane (or any suitable thermoplastic or hot melt adhesive). In one aspect, the binder 204 is a thermoplastic sheet with ten milligrams of carbon nanotubes per three grams of thermoplastic material.

In certain aspects, nanotubes are present in the binder layer at 0.001% to 10% by weight. In certain aspects, the fabric 202 has between 0.1% to 10% by weight nanotubes or ribbon-like material (either on a fabric surface or surfaces or in the fabric).

In certain embodiments according to the present invention, to form a backing according to the present invention a laminate layer 206 is placed on each side of layers 204 and, the combination is pressed in a press apparatus, e.g. at between 0.7 and 70 mPa (100 and 10,000 psi) while heated, e.g. to between 25° C. and 300° C.

The resulting armour or backing 200 can be formed into a desired shape by applying pressure to it, e.g., with a mould of desired shape and/or by heating it, e.g. in a heated press and then bending it or otherwise mechanically shaping it. FIG. 3B illustrates a backing 200a which has been formed with a ninety-degree bend. A backing according to the present invention may be any suitable thickness and, in certain aspects, ranges between 2.5 and 250 mm (0.1 and 10 inches) thick. A backing according to the present invention may be formed into any desired shape. Such a backing may itself be used as “soft” armour, e.g. for vehicles, aircraft (planes, helicopters, etc), and boats, or for parts thereof.

It is within the scope of this invention to use any desired number of binder layers and any number of fabric layers 202 including, but not limited to one, two, three, four, five, six, seven, eight, nine or ten. In certain aspects the fabric layers 202 (or any fabric layer in any embodiment hereof) are 0.0001 inches and 0.01 inches thick. In certain aspects, the binder layers 204 (or any binder layer in any embodiment herein) are between 2.5 and 250 μm (0.0001 and 0.01) inches thick.

FIG. 3C shows a backing 200b, like the backings 200 or 200a, which is used as armour for a thing or for a person.

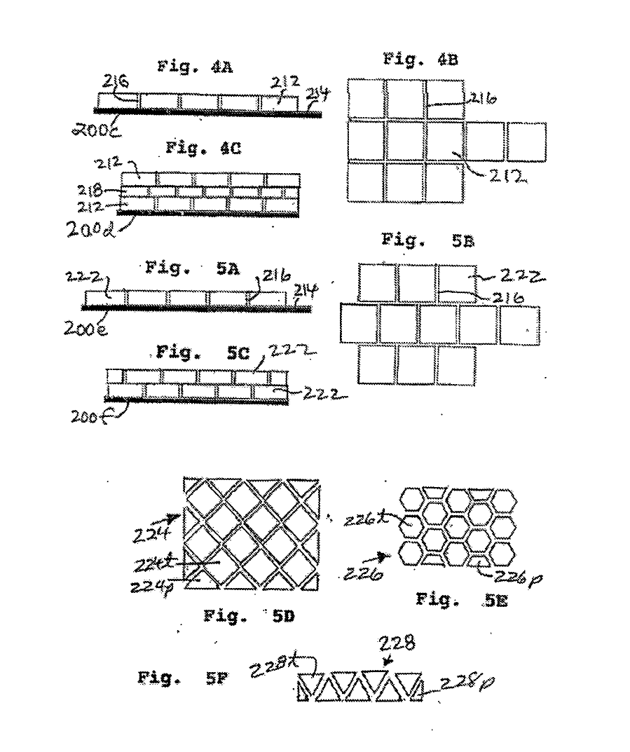

FIGS. 4A and 4B show an armour structure 210 according to the present invention which has a backing 200c (like any backing described above according to the present invention) which includes at least one binder layer like the layer 204, FIG. 3A, to which are adhered tiles 212 using adhesive 214. The tiles 212 may be any known tile used in armour or the tiles 212 may be made as described above by a method according to the present invention as an article according to the present invention with ceramic and, optionally, graphene ribbons.

In one aspect, the adhesive 214 (and any adhesive in any backing, armour or armour structure according to the present invention) is any suitable known adhesive. In one particular aspect the adhesive 214 is a polymer epoxy adhesive, (e.g. as in U.S. application 2006/0166003 (Khabashesku) Ser. No. 10/559,905 filed 16 Jun. 2004). Any adhesive disclosed or referred to herein may, according to the present invention, have carbon nanotubes and/or transformed nanotubes therein, or both.

An adhesive 216 is used between adjacent tiles 212. In one aspect, the adhesive 216 is any suitable known adhesive. In one aspect, the adhesive 216 is chosen for its elongation ability and its ability to withstand impacts.

The tiles 212 may have any suitable dimensions and any suitable shape (e.g. but not limited to, rectangular, square, triangular, parallelogram, pentagonal and hexagonal). In one particular aspect, the tiles are square and are two inches by two inches.

In adhering the tiles 212 to the backing 200c, the tiles 212 may be pressed against the backing 200c with heat, using a heated press with a heated platen(s) or roller(s).

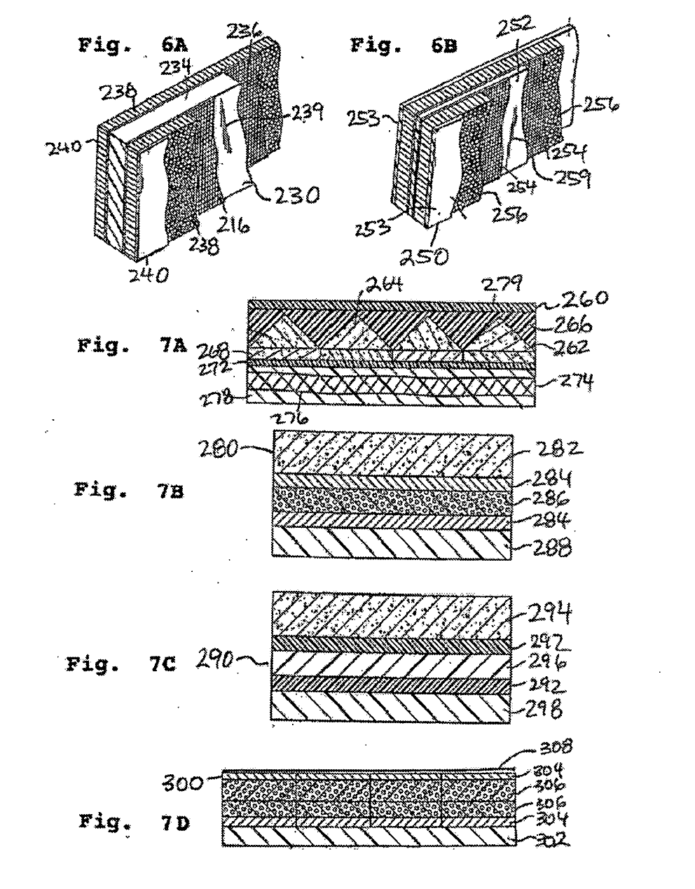

As shown in FIG. 4B, the tiles 212 are arranged in order with tiles 212 in one row, as viewed in FIG. 4B, lined up with tiles 212 in another row. Also, it is within the scope of the present invention to stack tiles one, two, three, etc. deep and, in one aspect, to have the stacked tiles line up with each other; or (as shown in FIG. 5C) to have stacked tiles offset from each other.

It is also within the scope of the present invention to stack tiles of different thickness; e.g., as shown in FIG. 4C, a backing 200d made as any backing according to the present invention described above, has tiles 212 in two columns with tiles 218 of a different thickness in an intermediate column. Different tiles may also, according to the present invention, be used in different rows (e.g. as in the rows of FIG. 4B).

FIG. 5A shows a backing 200e made as any backing above according to the present invention which has tiles 222 adhered thereto which includes at least one binder layer like the layer 204, FIG. 3A. As shown in FIG. 5B, tiles 222 in adjacent rows are offset with respect to each other. Adhesives 214 and 216 are used as in the structure of FIG. 4A.

Tiles according to the present invention may be used in patterns different from those in preceding figures. For example, see FIGS. 5D-5F. FIG. 5D shows armour 224 according to the present invention which is like the armour structure 210, but in which tiles 224t are in a diamond pattern employing partial tiles 224p. Adhesive used with these tiles is like that of the structures of FIGS. 4A-5C.

FIG. 5E shows armour 226 according to the present invention which is like the armour of FIGS. 4A-5D, but which has tiles 226t, as viewed from above, of a generally hexagonal shape. Partial tiles 226p are used at the structure's edges. Adhesive used with these tiles is like that of the structures of FIGS. 4A-5C.

FIG. 5F shows armour 228 according to the present invention which is like the armour of FIGS. 4A-5D, but which has tile 228t which are generally triangular as viewed from above and partial tiles 228p at edges. Adhesive used with these tiles is like that of the structures of FIGS. 4A-5C.

As shown in FIG. 5C, two (three, four, five or more) columns of tiles 222 may be used as in a backing 200f (made as any backing described above according to the present invention) with tiles in one column offset from those in an adjacent column.

The present invention provides improvements to the laminate barrier panel of U.S. Pat. No. 6,568,310 (incorporated fully herein for all purposes.

A panel 230 according to the present invention as shown in FIG. 6A has a layer 234 between two layers 236 of a mesh or mail material. A layer 238 of body material is located outwardly of the layers 236. Optionally, the layers 238 are covered by sheets or laminate 240. Optionally, adhesive is used between adjacent layers and/or to secure the sheets 20 to the layers 238. The layers 236 may be mesh or mail layers.

It is within the scope of the present invention to spray a film 239 (shown on a side of the layer 234) containing carbon nanotubes and/or ribbons onto any, some, or all surfaces of all layers of the panel 230 (as is true also for any embodiment herein with layers or plates). It is within the scope of the present invention to include ribbons in any, some, or all layers of the panel 230. It is within the scope of the present invention for any, some or all of the layers 234, 236, and/or 238 to be a suitable article with ceramic and, optionally, ribbons.

FIG. 6B shows a panel 250 according to the present invention which has a central layer 252 with a mesh or mail layer 254 on either side. Layers 256 of relatively light weight body material are on sides of the layers 254 and layers 258 are on sides of the layers 256. Layers 253 are on sides of the layers 256. The layers 252, 253, 256 and/or the layers 258 (as may be the layer 234, FIG. 6A) are, in one aspect made of ballistic material which includes ceramic and, optionally, ribbons. As with the panel 230, the layers of the panel 250 are connected together with an adhesive.

It is within the scope of the present invention to spray a film 259 (shown on a side of the layer 252) containing carbon nanotubes and/or graphene ribbons onto any, some, or all surfaces of all layers of the panel 250. It is within the scope of the present invention to include ribbons in any, some, or all layers of the panel 250. It is within the scope of the present invention for any, some or all of the layers 252, 254, and 256 to be a suitable article with ceramic and, optionally, ribbons.

The present invention provides new and nonobvious armour as compared to the composite armour of U.S. patent application Ser. No. 11/656,603 filed Jan. 23, 2007 (incorporated fully herein for all purposes).

An armour structure 260 according to the present invention as shown in FIG. 7A has a layer 262 (e.g. 5 mm to 60 mm thick) provided to disrupt an incoming projectile. Any, some, or all of the components of this layer 262 described below may be a suitable article made according to the present invention and may have ceramic and, optionally, graphene ribbons.

In one aspect the layer 262 includes tiles 264 (made in certain aspects as any tile described above according to the present invention) retained with a retaining material 266 (e.g. any suitable adhesive or polymer). Each tile 264 may be polygonal with a base 268 (e.g. bases between 30 mm and 60 mm wide). A backing 274 is adjacent the layer 262 (optionally, with a layer of adhesive 272 between them). The backing 274 may be like any backing according to the present invention described above or may be the lacking of the above-identified patent application 2009/0114083 (Moore) Ser. No. 11/656,603. The backing 274 may include a reinforcing layer 276 encased with a polymer 278. An optional spall layer 279 may be provided in the material 266. The spall layer may be any suitable fragment-containing material, e.g. synthetic plastic, thermoplastic, polycarbonate, or polymeric.

FIG. 7B shows an armour structure 280 according to the present invention which has a tile layer 282, confining layers 284, a ceramic layer 286 and a backing layer 288. The tile layer 282 may be made as any tile according to the present invention described herein. The confining layers 284 may be any backing according to the present invention described herein, a layer according to the present invention, or a metal or fiber reinforced composite (with or without ribbons, with or without carbon nanotubes).

The ceramic layer 286 may be any suitable backing according to the present invention described above or it may be a suitable article according to the present invention with ceramic, carbon nanotubes, and/or ribbons according to the present invention as described above. Layers of the armour structure 280 may be adhered together with adhesive and/or layer with nanoenhanced elastomer according to the present invention, and any, some, or all of the layers may have a film with graphene ribbons and/or carbon nanotubes thereon.

FIG. 7C shows an armour structure 290 according to the present invention which has a tile layer 294 between adhesive layers 292. A strengthening layer 296 is provided between the layers 292 (which may be a layer according to the present invention with nanoenhanced elastomer). A backing layer 298 is provided adjacent one of the layers 292 (which may be a layer according to the present invention with nanoenhanced elastomer). The tile layer 294 may be any tile or tiles according to the present invention described herein; a suitable backing according to the present invention (any as described herein); a layer including ceramic and, optionally, graphene ribbons; or a suitable article according to the present invention (any as described herein) with ceramic and, optionally, graphene ribbons.

The adhesive layers 292 may be any suitable known adhesive or, according to the present invention, an adhesive with nanotubes and/or ribbons. The layer 296 may be any suitable backing according to the present invention or any suitable article according to the present invention described herein or a glass layer of strengthened glass; glass and ceramic; or glass, ceramic and graphene ribbons and/or with carbon nanotubes. The layer 298 may be any backing according to the present invention or article according to the present invention described herein.

FIG. 7D shows an armour structure 300 according to the present invention which has ceramic layers 306 encased in an optional shell (e.g. cam or cylinder) 308 with optional confining layers 304 and a backing layer 302 (which may be a layer according to the present invention with nanoenhanced elastomer). The confining layers 304 may be like the layers 54 in U.S. application Ser. No. 11/656,603 or they may be any backing according to the present invention or article according to the present invention described herein. Optionally the confining layer may contain ribbons and/or nanotubes (e.g., but not limited to, carbon nanotubes) according to the present invention or ceramic with ribbons.

As with the layers of the structures of FIGS. 7A-7C the layers of the structure 300 may be adhered together with suitable adhesive and/or with a layer according to the present invention (which may be a layer according to the present invention with nanoenhanced elastomer). As with any layer, article, backing or component of any of the disclosures of FIGS. 4A-12D, any layer of the structure 300 may have a film thereon which includes graphene ribbons and/or carbon nanotubes and/or is like any film or layer according to the present invention described herein.

The present invention provides new modular panels which are neither taught by nor suggested by U.S. application 2009/0047502 (Folaron) Ser. No. 12/189,684 filed Aug. 11, 2008 (incorporated fully herein for all purposes). FIG. 8 shows a panel 320 according to the present invention with layers 321, 322, 323, 324, 325, 326, 327, 328 and 329, with adjacent layers connected to each other, e.g. with adhesive between layers. In one aspect, layers 322-324 and 327, 328 are woven layers, any one, two or all of which may be deleted according to the present invention; any one, two, three or all of which may be made of material that includes ceramic and ribbons according to the present invention; and any one, two, three or all of which may be any suitable backing or layer according to the present invention or any suitable article according to the present invention as described hereinabove. In one aspect these layers 322-324, 327 and 328 are woven polypropylene with a thickness between 0.005 and 0.006 inches (e.g. 0.132 mm) and a weight of about 0.02 lbs. per square foot.

In one aspect the polypropylene is coated (e.g. sprayed) with carbon nanotubes and/or with graphene ribbon-like material. In another aspect the woven material is a mixture of polypropylene and graphene ribbon-like material and/or carbon nanotubes. In one aspect the layers (or any of them) 322-324 and/or 327, 328 are any suitable backing or layer according to the present invention or any suitable article according to the present invention as described herein.

Layers 321, 325, and 329 are planar layers made, e.g., of: polyurethane film 0.25-0.4 mm (0.010 to 0.015 inches) thick; a film of polyurethane and graphene ribbon-like material; a film of polyurethane, ribbons and carbon nanotubes; or a film of polyurethane and carbon nanotubes. In one aspect the film is any suitable film or layer according to the present invention described (including layers with nanoenhanced elastomer). Any one, two or all the layers 321, 325, 329 may be deleted.

Layer 326, made of any suitable material of sufficient strength (including, but not limited to, materials as disclosed in U.S. application Ser. No. 12/189,684 or any of these materials with graphene ribbons) encapsulates rods 330. Optionally the rods are deleted. In one aspect the layer 326 is about an inch thick. In one aspect the rods 330 are about an inch in diameter. The rods may be made of any suitable material including, but not limited to, those disclosed in U.S. application Ser. No. 12/189,684 or these materials with graphene ribbon-like material and/or with carbon nanotubes.

In one aspect the layer 326 is any suitable backing or layer according to the present invention (including a layer with nanoenhanced elastomer) or suitable article according to the present invention described herein. In one aspect, the rods 330 are an article (of rod shape) as any such article according to the present invention as described herein. Optionally the layer 326 is deleted.

The present invention provides new and nonobvious armour which is neither taught nor suggested by U.S. application 2003/0167910 (Jared) Ser. No. 10/094,849 filed Mar. 4, 2002 (incorporated fully herein for all purposes). FIG. 9 shows armour 340 according to the present invention with a core 342 having spaces 344 each containing one (or at least one) insert 350. Sheets 344, 346 (either or both of which may be deleted) are on sides of the core 342. Any of these sheets may be a layer of nanoenhanced elastomer.

In certain aspects, each insert 350 is made of ceramic; ceramic with carbon nanotubes; ceramic with ribbons according to the present invention; or ceramic with ribbons and carbon nanotubes. In one aspect each insert 350 is a tile according to the present invention as any tile according to the present invention described herein, or an article according to the present invention as any such article described herein.

In one aspect the core 342 is made of any material disclosed in U.S. application Ser. No. 10/094,849; any such material with carbon nanotubes; any such material with graphene ribbon-like material; any such material with carbon nanotubes and ribbons; or any such material with nanoenhanced elastomer. In one aspect the core 342 is a suitable article according to the present invention, as any such article described herein, with the spaces 344. The spaces 344 may be any chosen shape to accommodate inserts 350 of any chosen shape, including, but not limited to, any shape as disclosed in FIGS. 2A-2Y, 4A, 7A and 8.

Sheets 344, 346 may be any sheet disclosed in Ser. No. 10/094,849; any such sheet with carbon nanotubes; any such sheet with ribbons; any such sheet with nanoenhanced elastomer according to the present invention; or any such sheet with carbon nanotubes and ribbons. In certain aspects the sheets 344, 346 are any suitable backing or layer according to the present invention or any suitable article according to the present invention disclosed herein.

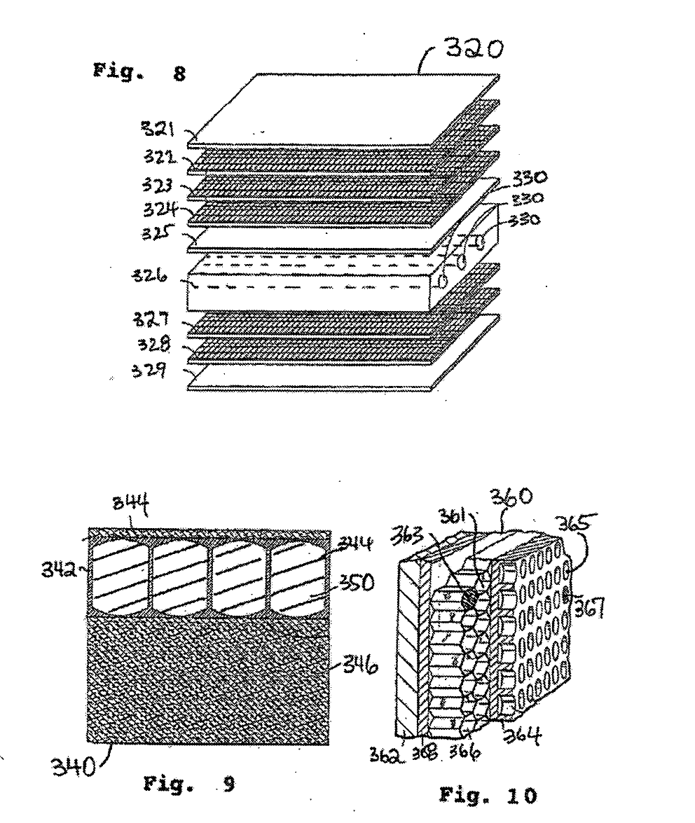

The present invention discloses new and nonobvious armour which is neither taught nor suggested by U.S. Pat. No. 5,221,807 (incorporated fully herein for all purposes). FIG. 10 shows armour 360 according to the present invention which has a plate 362, a plate 364, a layer 366 between the plates, and, optionally, a plate 368. Each of these plates and layers may be of material as described in U.S. Pat. No. 5,221,807; with nanoenhanced elastomer; with carbon nanotubes; and/or with ribbons.

In certain aspects, the plates 362, the plate 364, and/or the plate 368 are any suitable backing or layer according to the present invention or any suitable article according to the present invention described herein. They may be solid or, as shown in FIG. 10, they may have a series of openings or spaces (as may any article according to the present invention described herein).

As is true for any embodiment of the present invention in which an item, layer, plate, backing or article has an opening, openings, a space, or spaces, each space 361 in the plate 366 may be filled with material 363 including ceramic and/or graphene ribbon-like material (one such space indicated with material 363 in FIG. 10) and each opening 365 in the plate 364 may be filled with material 367 including ceramic and/or graphene ribbon-like material (one such space indicated with material 367 in FIG. 10). The material 363 and/or the material 367 may be any suitable backing or layer according to the present invention or any suitable article according to the present invention described herein.

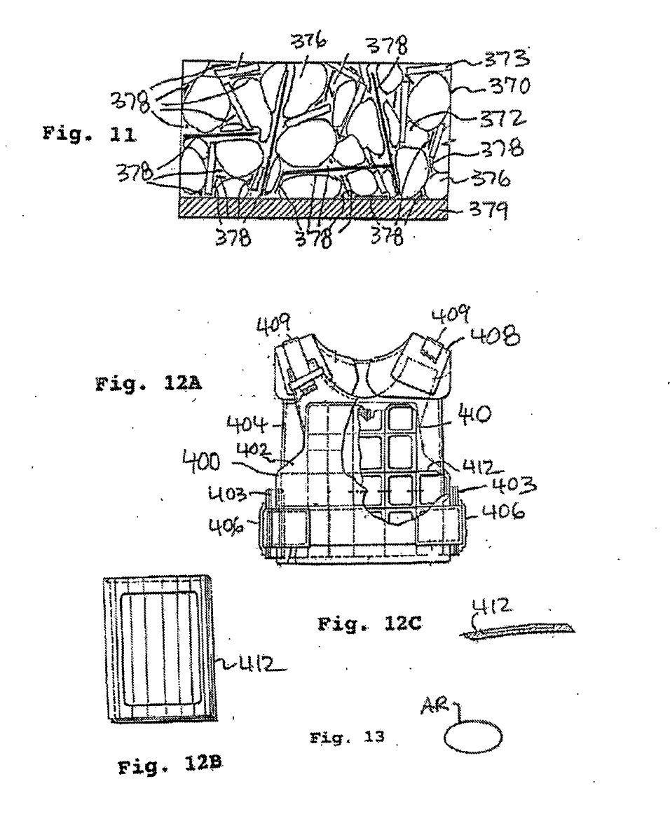

The present invention provides armour which is neither disclosed in nor suggested by U.S. Pat. No. 7,041,372 (incorporated fully herein for all purposes. Armour 370 according to the present invention as shown in FIG. 11 has an optional substrate 379 and a matrix 372 on the substrate 379 (when the substrate 379 is present). The matrix 372 includes unit components 376 which may be, e.g., any suitable metal or ceramic, including, but not limited to, any suitable metal or ceramic disclosed in U.S. Pat. No. 7,041,372; ceramic with ribbons; nanoenhanced elastomer; or ceramic with carbon nanotubes.

The matrix 372 may be any suitable backing or layer according to the present invention or any suitable article according to the present invention as described herein. The substrate 379 may be any substrate as disclosed in U.S. Pat. No. 7,041,372 or any suitable backing or layer according to the present invention or any suitable article according to the present invention as described herein.

As shown in FIG. 11 (not to scale), the matrix 372 has the units 376, optional carbon nanotubes 373, and optional ribbons 378.

The present invention provides new and nonobvious armoured clothing neither disclosed in nor suggested by U.S. Pat. No. 5,996,115 (incorporated fully herein for all purposes). FIG. 12A shows a vest 400 according to the present invention with a plurality of tiles 410, 412. The tiles 410, 412 may be any tile according to the present invention described herein. Parts of the vest 400—front 402, rear 404, sides 406, top 408, straps 409--may be made of or contain, any suitable backing or layer according to the present invention as described herein. The sides 406 may include tiles 403 (as any tile according to the present invention).

It is within the scope of the present invention to make any known article, thing, item, product, device, apparatus, or structure (all collectively referred to as “article” or “articles”) previously made of elastomer or a combination of elastomers with an elastomer or combination of elastomers according to the present invention. It is within the scope of the present invention to make any known article, thing, item, product, device, apparatus, or structure (all collectively referred to as “article” or “articles”) previously made of rubber or of an elastic material or a combination of such with an elastomer or combination of elastomers according to the present invention. “Articles” can include, but are not limited to, seals, gaskets, tires, toys, balls, bumpers, vibration mounts, shock absorbers, bellows, expansion joints, catheters, bearing pads, stoppers, gloves, balloons, tubing, conduits, pipe, casing, adhesives, footwear, grommets, bushing, bearing, clothing, fasteners, connectors, washers, inner tubes, diaphragms, roofing material, hose, valve balls, valve seats, hydraulic cups, o-rings, rollers, wheels, spark plug caps, computer parts, cell phone parts, keyboards, mouse pads, filters, filter media, golf balls, housing, electronic housings, computer cases and housings, cellphone cases and housings, prosthetics, dielectric elastomer actuators, screen, shale shaker seals and mounts, shale shaker screen seals and mounts, top drive seals, drill bit seals and bearings, and blowout preventer seals.

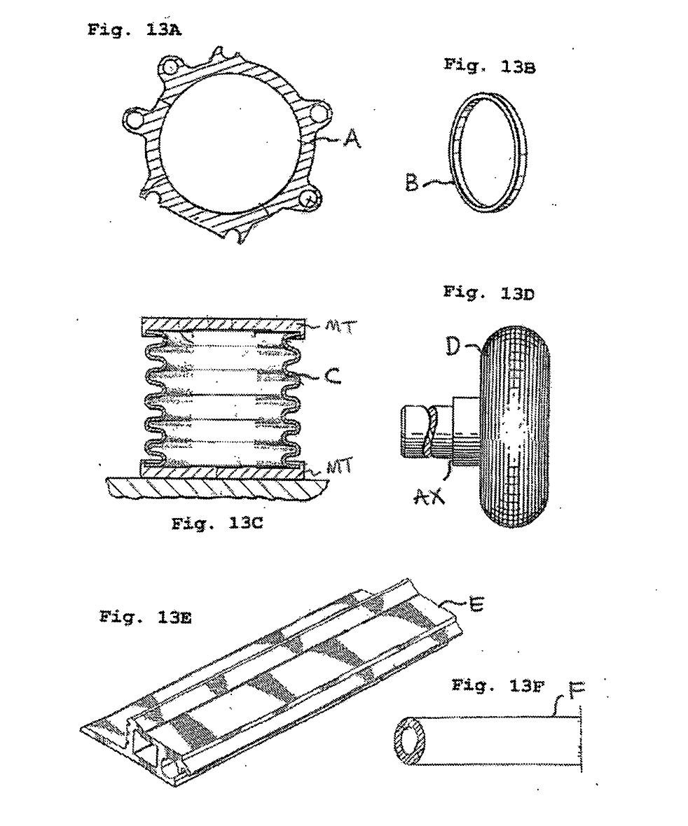

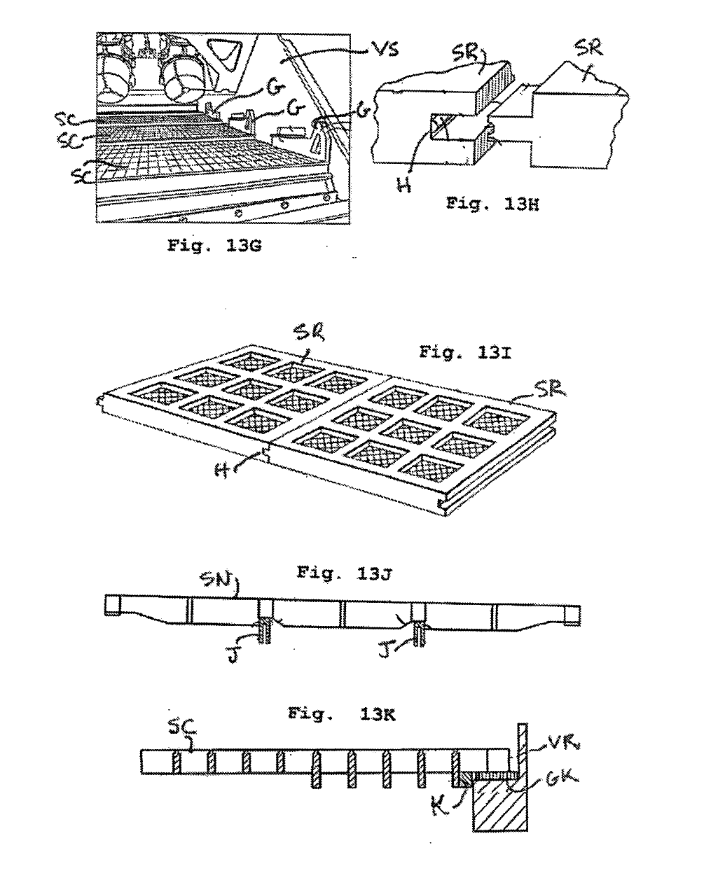

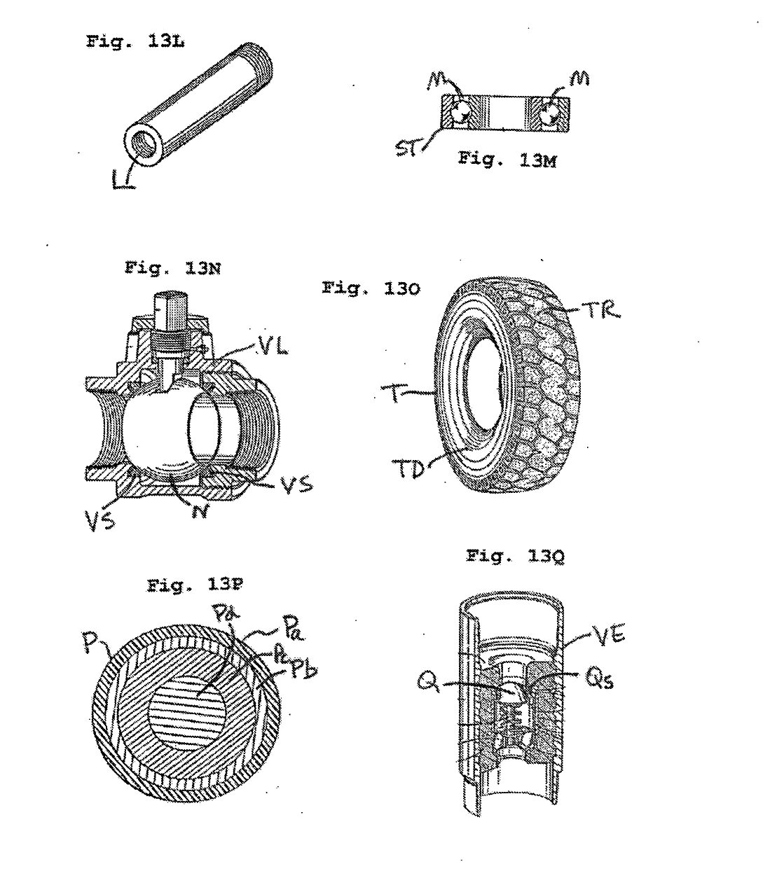

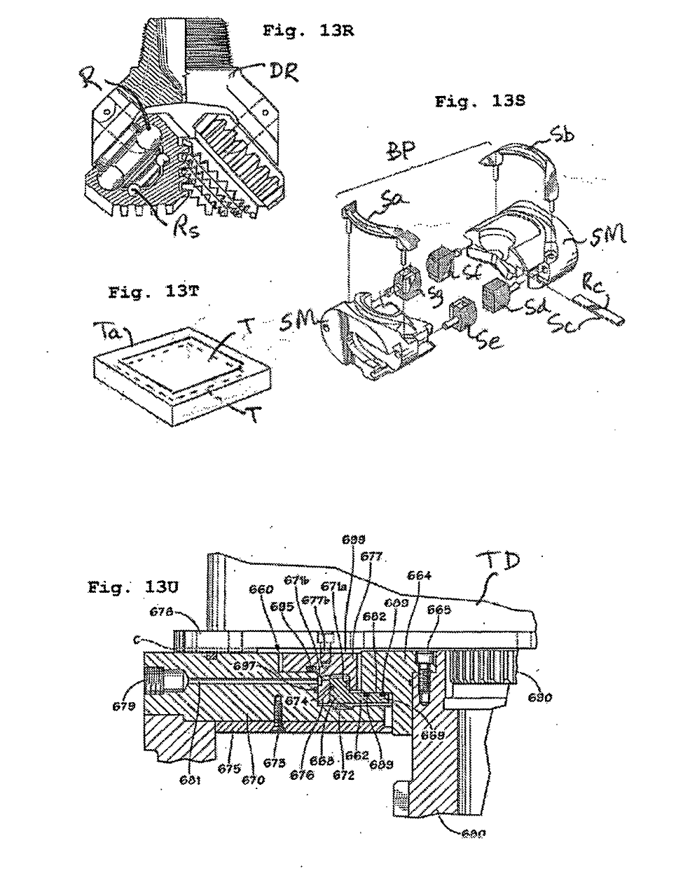

FIG. 13 shows schematically an article AC according to the present invention. The article AC represents any article mentioned in the previous paragraph either in general or as a particular example.

FIG. 13A shows a gasket A according to the present invention made of a nanomaterial-enhanced elastomer or elastomers according to the present invention

FIG. 13B shows an O-ring B according to the present invention made of a nanomaterial-enhanced elastomer or elastomers according to the present invention

FIG. 13C shows a bellows C between mounts MT according to the present invention made of a nanomaterial-enhanced elastomer or elastomers according to the present invention.

FIG. 13D shows a roller D on an axle AX according to the present invention made of a nanomaterial-enhanced elastomer or elastomers according to the present invention.

FIG. 13E shows an expansion joint E according to the present invention made of a nanomaterial-enhanced elastomer or elastomers according to the present invention.

FIG. 13F shows a hose F according to the present invention made of a nanomaterial-enhanced elastomer or elastomers according to the present invention FIG. 13G shows screen holders G according to the present invention for screens SC of a vibratory separator VS (e.g. but not limited to, a shale shaker), the holders G made of a nanomaterial-enhanced elastomer or elastomers according to the present invention.

FIGS. 13H and 131 show a seal H for screens SR of a vibratory separator (e.g. but not limited to, a shale shaker), the seal H made of a nanomaterial-enhanced elastomer or elastomers according to the present invention.

FIG. 13J shows screen supports J according to the present invention for supporting a screen, e.g. a screen SN, e.g., a screen for a vibratory separator VR, shown partially (e.g, but not limited to, a shale shaker), the supports J made of a nanomaterial-enhanced elastomer or elastomers according to the present invention.

FIG. 13K shows a screen seal K according to the present invention for sealing an interface with the screen SC, e.g. a screen for a vibratory separator VR, shown partially (e.g. but not limited to, a shale shaker), the seal K made of a nanomaterial-enhanced elastomer or elastomers according to the present invention. A mounting gasket or seal GK on the screen SC and/or on the vibratory separator VR is made of a nanomaterial-enhanced elastomer or elastomers according to the present invention.

FIG. 13L shows a threaded tubular L (e.g., pipe, casing, tubing, conduit, riser) according to the present invention made of a nanomaterial-enhanced elastomer or elastomers according to the present invention. The threading at either or both ends may be deleted.

FIG. 13M shows ball bearings M (within structure ST) according to the present invention, the ball bearings M made of a nanomaterial-enhanced elastomer or elastomers according to the present invention.

FIG. 13N shows a ball N for a valve VL according to the present invention, the ball N made of a nanomaterial-enhanced elastomer or elastomers according to the present invention. Optionally, valve seats or seals VS are made of a nanomaterial-enhanced elastomer or elastomers according to the present invention.

FIG. 13O shows a tire T according to the present invention, the ball bearings M made of a nanomaterial-enhanced elastomer or elastomers according to the present invention. Optionally only the tire tread TR is made of a nanomaterial-enhanced elastomer or elastomers according to the present invention; or optionally only the tire sidewall TD is made of a nanomaterial-enhanced elastomer or elastomers according to the present invention.

FIG. 13P shows a golf ball P (in cross-section) according to the present invention, the golf ball P made of a nanomaterial-enhanced elastomer or elastomers according to the present invention. The golf ball P has layers Pa, Pb, and Pc and a core Pd. Any, some, one or all of these may be made of a nanomaterial-enhanced elastomer or elastomers according to the present invention. Optionally, such a golf ball according to the present invention is only a solid spherical core P made of a nanomaterial-enhanced elastomer or elastomers according to the present invention. Optionally any one or two of the layers may be deleted. Optionally, the core P may be deleted.

FIG. 13Q shows a head Q of a valve VE according to the present invention, the head Q made of a nanomaterial-enhanced elastomer or elastomers according to the present invention. In one aspect, the valve VE is a wellbore cementing valve. Optionally, a valve seat Vs is made of a nanomaterial-enhanced elastomer or elastomers according to the present invention.

FIG. 13R shows a drill bit DR according to the present invention. It is within the scope of the present invention to make bit bearings and/or bit seals of an elastomer or combination of elastomers according to the present invention. Bearings R and seals Rs of the bit DR are made of a nanomaterial-enhanced elastomer or elastomers according to the present invention.

FIG. 13S shows, in exploded view, parts of a blowout preventer BP (shown partially) according to the present invention. It is within the scope of the present invention to make seals for a blowout preventer of an elastomer or combination of elastomers according to the present invention; e.g., for an apparatus as disclosed in U.S. Pat. No. 7,354,026 incorporate fully herein for all purposes. Seals Sa-Sg (like those in U.S. Pat. No. 7,354,026, but with improvements according to the present invention) for seal holders SM of rams for a blowout preventer are made of a nanomaterial-enhanced elastomer or elastomers according to the present invention.

FIG. 13T shows a dielectric actuator Ta according to the present invention with spaced-apart opposed elastomeric cathodes T according to the present invention made of a nanomaterial-enhanced elastomer or elastomers according to the present invention.

It is within the scope of the present invention to make the seals, gaskets, and/or bearings used with or in wellbore top drives and their associated structures from nanomaterial-enhanced elastomer or elastomers according to the present invention. FIG. 13U show part of a top drive TD as disclosed in U.S. Pat. No. 7,472,762 (incorporated fully herein for all purposes), including the numeral part labels in FIG. 13U. Seals, seal member, and/or O-rings—bearing indication numerals 662, 664, 689, 674, 671a, 697 and 695—are made of nanomaterial-enhanced elastomer or elastomers according to the present invention (or any one or some of these, if not all, is so made).

FIG. 22 shows a shale shaker 220 in accordance with the present invention which has a screen-mounting basket 222 and two vibrating apparatuses A. The basket 222 has bracket 226 to which are secured helical springs 228. Each spring 228 is secured to a base member 227. An optional housing 224 may be used on sides of and beneath the shale shaker 220. The brackets 226 are made of a nano-enhanced elastomer (any of sufficient strength and/or sufficient hardness according to the present invention), and/or the base members 227 are made of a nano-enhanced elastomer (any of sufficient strength according to the present invention). Shale shakers similar to the shale shaker 220, but with no teaching, motivation, or suggestion of using nano-enhanced elastomers for parts of a shaker, are disclosed in U.S. Pat. Nos. 6,155,428 and 7,581,647, both incorporated fully herein for all purposes.

FIG. 23 shows a vibratory apparatus 230 in accordance with the present invention, which has a base 231 on which is mounted a frame 232. Vibration damping supports 234 on the base 231 support the frame 232. Vibratory apparatus 235 connected to the frame 232 vibrates the frame 232 and thus vibrates any member 236 (shown schematically) on the frame 232. The supports 234 are made of a nano-enhanced elastomer (any of sufficient strength and/or sufficient hardness according to the present invention and able to withstand encountered temperatures and pressures and to reduce vibrations).

In one particular aspect, the member 236 is one or a plurality of screens or screen assemblies used to screen material fed to the apparatus 230. In one aspect, the apparatus 230 is a shale shaker. A similar shale shaker is disclosed in U.S. Pat. No. 5,685,982, incorporated fully herein for all purposes, but this patent has no teaching, motivation, or suggestion of using nano-enhanced material for a shale shaker or parts thereof.

FIG. 24 shows a vibratory separator 240 in accordance with the present invention which has a stationary base 241 and a moving frame 242 moved by apparatus 244 connected to the fame 242. Intervening resilient members 243 are positioned between brackets 249 of the frame 242 and posts 247 of the base 241. Screens 245 are mounted on decks 246. It is to be understood that although only one side of the separator 60 is shown in FIG. 24, the other side is like the side that is shown (as is true for the apparatus of FIG. 23 also). The members 243 are made of a nano-enhanced elastomer (any of sufficient strength and/or sufficient hardness according to the present invention and able to withstand encountered temperatures and pressures and to reduce vibrations).

FIG. 25 shows a shale shaker 250 with basket spring mounts 252 which are made of nano-enhanced material according to the present invention or which have a portion 254 made of a nano-enhanced elastomeric material according to the present invention (of sufficient strength and/or of sufficient hardness). Optionally, base members 256 for mounting springs 251 have a top portion 258 made of a first nano-enhanced material according to the present inventions and a second part 259 made of a second nano-enhanced material according to the present invention. Optionally, the first material is stronger than the second material, or vice-versa. Optionally, the first material is harder than the second material, or vice-versa. The chosen nano-enhanced elastomer material is any of sufficient strength and/or sufficient hardness according to the present invention and able to withstand encountered temperatures and pressures and to reduce vibrations.

FIGS. 26A and 26B disclose a structural member 260 in accordance with the present invention. This member may be used to mount another member or structure and it may be used for vibration damping. In one particular aspect, it may be used with vibratory separators and shale shakers; e.g., to mount a screen, to mount a basket or to mount a spring. In one particular aspect the member 260 is used for mounting springs or other isolators between a screen support and a base or housing. As shown the member 260 has a plurality of rings of different material. In one aspect rings 261 and 263 and a core 265 are made from rigid material; e.g., but not limited to, rigid metal, fiberglass, or composite material; and the rings 262, 264 are made from nano-enhanced elastomer material according to the present invention (of sufficient strength and/or of sufficient hardness). Alternatively, the rings 262, 264 are made of the rigid material and the rings 261, 263 and core 265 are made of the nano-enhanced elastomer material.

It is within the scope of the present invention to use any desired number of rings of either material. The chosen nano-enhanced material is any of sufficient strength and/or sufficient hardness according to the present invention and able to withstand encountered temperatures and pressures and to reduce vibrations.

FIG. 27 shows a member 270 in accordance with the present invention with a base 271 made of any suitable material; e.g., metal, fiberglass, plastic, or composite material. On one side (e.g., a bottom) of the base 271 is a layer 72 of nano-enhanced elastomer material according to the present invention (any disclosed herein of sufficient strength and/or sufficient hardness). On an opposing side of the base 271 (e.g., a top) is a layer 273 of nano-enhanced elastomer material according to the present invention (any disclosed herein of sufficient strength and/or sufficient hardness). As shown, the layer 273 is about twice as thick as the layer 272, but each layer may be any desired thickness. In certain particular aspects, for a particular application, the layers are sufficiently thick to provide vibration damping between two things, one on one side of the member 270 and the other on an adjacent or opposite side. The chosen nano-enhanced material is any of sufficient strength and/or sufficient hardness according to the present invention and able to withstand encountered temperatures and pressures and to reduce vibrations.

FIG. 28 shows a support 280 which has a body 282 and an inner core 284 within which are a plurality of spaced-apart rods or discs 285 which extend through the core 284 and have ends that project into the body 282. Such a structure may be used as a vibration damping member between two other members. In certain aspects the body 282 is made of relatively rigid material (e.g., metal, plastic, fiberglass, or composite material) and the core 284 and/or the discs or rods 285 are made of nano-enhanced elastomer material according to the present invention (of sufficient strength and/or of sufficient hardness), or vice-versa, the body 282 is made of the nano-enhanced material and the other parts are made of the rigid material. In any aspect, the body 282 may be made of the elastomer material. The body 282 and the core 284 may have a top cross-section like that of the member in FIG. 26A, or a circular crosssection, or they may have (as is true for the member 270) any desired cross-sectional shape, including, but not limited to, triangular, square, rectangular, pentagonal or hexagonal. Any member, base, mount or structural part disclosed herein in accordance with the present invention may have the rods or discs or core of the support 280 and/or a ring or rings or core as in the member 270. The chosen nano-enhanced elastomer material is any of sufficient strength and/or sufficient hardness according to the present invention and able to withstand encountered temperatures and pressures and to reduce vibrations.

FIG. 29 shows a mount apparatus 290. In one aspect, the apparatus 290 is used as a vibration isolator or vibration damping member between two other members (with or without a spring). In one aspect, the apparatus 290 is used as a mount for a spring 291. The apparatus 290 is made of nano-enhanced elastomer material according to the present invention of sufficient strength and/or of sufficient hardness. Extending between ends 292, 293 is a shaft 294 encircled by the spring 291. The chosen nano-enhanced elastomer material is any of sufficient strength and/or sufficient hardness according to the present invention and able to withstand encountered temperatures and pressures and to reduce vibrations.

The present inventions provides vibrationally and acoustically insulated devices disposable within a structure housing including: a vibration damping portion fixed to and substantially contiguous with at least a portion of a surface of the structure housing for damping vibrations transmitted through the structure housing; and an acoustic absorbing portion fixed proximate the vibration damping portion for reducing reverberating acoustic waves within the structure; the vibration damping portion including a constrained damping layer having at least one continuous damping layer fixed to the at least a portion of a surface of the structure housing and a segmented constraining layer fixed to at least a portion of the at least one continuous damping layer—one or all of the vibration damping portion, acoustic absorbing portion, the at least one continuous damping layer and the segmented constraining made entirely of or at least partially of nano-enhanced elastomer material according to the present invention (of sufficient strength and/or hardness); or may be made of any of the materials in U.S. Pat. No. 5,712,447 or in references cited in this patent. Such devices, in certain embodiments, are improvements of devices disclosed in U.S. Pat. No. 5,712,447 which is incorporated fully herein for all purposes.

The present invention vibration and acoustic insulating devices for vibrationally and/or acoustically insulating a member, e.g., a body or a structure housing from a source of generated noise and vibrations, the vibration and/or acoustic insulating device including: a continuous damping layer positioned over and fixed to at least a portion of a surface of the member or structure housing for providing a first reduction in vibrational energy transmitted through the member or structure housing; a segmented constraining layer having a plurality of individual rigid segments fixed to the continuous damping layer with a predetermined distance between each of the plurality of individual rigid segments, for providing a second reduction of vibrational energy transmitted through the member or structure housing and the continuous damping layer; at least one mount, for mounting to the segmented constraining layer; optionally, the at least one mount including a fastener engaging portion fixed to and extending from the segmented constraining layer and a fastener joined to the fastener engaging portion; an acoustic absorption layer mounted to the segmented constraining layer with the at least one mount for reducing noise generated within the member or structure housing; and, optionally, an acoustic barrier layer disposed between the segmented constraining layer and the acoustic absorption layer and having a predetermined thickness corresponding to a predefined noise frequency region. Any or all, or at least one of, layers, mounts, and/or fasteners constraining may be made entirely of or at least partially of nano-enhanced elastomer material according to the present invention (of sufficient strength and/or hardness); or may be made of any of the materials in U.S. Pat. No. 5,712,447 or in references cited in this patent. Such devices, in certain embodiments, are improvements of devices disclosed in U.S. Pat. No. 5,712,447 which is incorporated fully herein for all purposes. The chosen nano-enhanced elastomer material is any of sufficient strength and/or sufficient hardness according to the present invention and able to withstand encountered temperatures and pressures and to reduce vibrations.

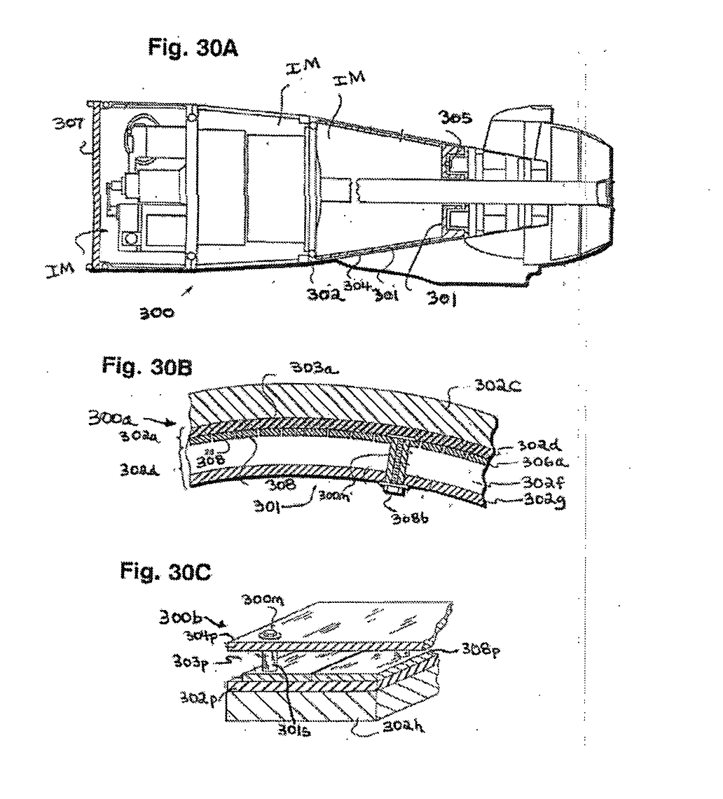

A vibrationally and acoustically insulated structure 300 as shown in FIG. 30A according to the present invention generally includes a structure housing 302 and a vibration and acoustic insulating device 301 fixed to at least a portion of the structure housing 302. In the vibrationally and acoustically insulated structure 300, the structure housing 302 encloses internal mechanisms IM such as motors, gears, and propulsion units that generate noise and vibrations. In certain aspects, for example, members and structures according to the present invention have a vibration and/or acoustic insulating device 301 on an interior of a vehicle, e.g., a plane, personnel carrier, helicopter, automobile, submarine, or underwater vehicle, e.g. such as a torpedo.

The vibration and acoustic absorbing device 301 is mounted proximate at least a portion of an interior surface 304 of the structure housing 302. In one aspect, the vibration and acoustic insulating device 301 can be mounted throughout the entire interior surface 304 or mounted over selected portions in areas which are particularly susceptible to vibrations or reverberating acoustic waves. For example, in a torpedo or other similar underwater vehicle, the vibration and/or acoustic insulating device is mounted around the interior surface 304 and on a bulkhead 305 and an endplate 307. The device, or part thereof, is made of nano-enhanced elastomer material according to the present invention (of sufficient strength and/or sufficient hardness).

As shown in FIG. 30B, a vibration and/or acoustic insulating device 300a according to the present invention includes a vibration damping portion 302a such as a constrained damping layer for damping vibrations transmitted through a structure housing 302c, and an acoustic absorbing portion 302d, for reducing reverberating acoustic waves within the structure. The vibration damping portion 302a is fixed to at least a portion of a structure housing surface 303a by bonding. The acoustic absorbing portion 302d is fixed against the vibration damping portion 302a, by one or more mounts 300m.

For embodiments of FIGS. 30A-30C, the chosen nano-enhanced elastomer material is any of sufficient strength and/or sufficient hardness according to the present invention and able to withstand encountered temperatures and pressures and to reduce vibrations.

In the vibration damping portion 302a, a continuous damping layer 302d is fixed to and positioned substantially in contact with at least a portion of the surface 303a. A segmented constraining layer 306a is fixed to and positioned over at least a portion of the continuous damping layer 302d. The vibration damping portion 302a provides damping by dissipating vibrational energy waves traveling through the structure housing 302c. In the absence of any damping portion, a vibrational energy wave will travel through the structure housing freely, and the structure housing acts as an acoustic radiator. When a layer of damping material 302d is added to the structure housing surface 303a, the continuous damping layer 302d causes the vibrational energy wave to be sheared as it travels through the structure housing 302c. Since the sheared waves travel through the continuous damping layer 302d and structure 302c at different speeds, the sheared vibrational energy waves destructively interact and dissipate the vibrational energy. The vibrational energy is further dissipated by adding optional individual segments 308 that propagate energy between each segment. The segments 308 also act to reduce the movement of the damping material 302d.

In one aspect, the continuous damping layer 302d is or may be made of nano-enhanced elastomer material according to the present invention of sufficient strength and/or hardness to withstand encountered temperature environments and to sufficiently reduce vibrations. The thickness of the damping layer 302d should be sufficient to reduce structural vibrations in the vibrating structure 303a. The plurality of segments 308 of the segmented constraining layer 306a are or may be made of nano-enhanced elastomer material according to the present invention of sufficient strength and/or hardness to withstand encountered temperature environments and to sufficiently reduce vibrations.

The continuous damping layer 302d is preferably bonded to the structure housing surface with a suitable known bonding compound, such as acrylic adhesives or any suitable two part epoxy. as are the segments 308. The acoustic absorbing portion 302d generally includes an acoustic barrier layer 302f and an acoustic absorption layer 302g. The acoustic absorption layer 302g and acoustic barrier layer 302f may be mounted to the structure housing 302c with one or more mounts 300m fixed to the constrained damping layer 302a (or vibration damping portion). Bolts 308b may be used to secure the layer 302g in place.

Any and all layers of the device 300a may be made of nano-enhanced elastomer material according to the present invention of sufficient strength and/or hardness to withstand encountered temperatures and to sufficiently reduce vibrations.

A device 300b according to the present invention as shown in FIG. 30C has an acoustic barrier layer 303p which includes an air space. This acoustic barrier layer of free air space can be used in an enclosed structure that is not susceptible to internal fluids, such as an underwater vehicle that does not permit fluid build up. As pressure or acoustic waves pass through the free air space in the acoustic barrier layer, the air space acts as an acoustic barrier to reduce the intensity of the waves. A standoff member 301s is used with a bolt 300m to mount an acoustic absorption material layer 304p at a distance from a structure, e.g., a hull structure 302h. The mounts 300m may be any suitable known isolation mount. A layer 302p is like the layer 302d, FIG. 30B and segments 308p are like segments 308, FIG. 30B.

Any and all layers and/or segments of the device 300b may be made of nano-enhanced elastomer material according to the present invention of sufficient strength and/or hardness to withstand encountered temperatures and pressures and to sufficiently reduce vibrations.

The present invention provides an acoustic and/or vibration attenuation composite, e.g., but not limited to damping tiles of the Type VI class 1, suitable for use, e.g., in aircraft, ship and submarine applications, that is inexpensive, does not result in an unacceptable weight penalty, and is conformable-in-place to complex curvatures. In certain aspects, such a an acoustic and/or vibration attenuation composite includes an elastomeric layer having a first and second surface; and a constraining layer with at least one ply of bonded to one of the surfaces of the elastomeric layer. The elastomeric layer is made entirely of or at least partially of nano-enhanced material according to the present invention.

In certain aspects such an acoustic and/or vibration attenuation composite has a composite constraining layer of at least one ply of fabric bonded to an elastomer layer made entirely or at least partially of nano-enhanced elastomer material according to the present invention, which, in certain particular aspects is a nano-enhanced rubber material. Any suitable fabric may be used, including, but not limited to, graphite fabric, i.e. cloth, for the constraining layer can be cut to fit large surface areas with shears or electrically operated rotary blades. One or more layers of the fabric may be used. In one aspect, the fabric is present in at least one ply, although a multi-ply fabric reinforcement can be used.

The thickness of the composite constraining layer is determined by the particular use, and can range, for instance, upwards from about 0.1 cm to about 3 cms or from about 0.25 cm to about 1.3 cm. For certain submarine applications, a thickness of about 0.50 cm to about 0.75 cm can be used. The thickness can, if desired, be greater than about 1.3 cm, depending on the vibration frequencies to be damped and the thickness of the elastomer layer. The constraining layer thickness selected relates generally proportionally to the thickness of the elastomer layer which can range, for instance, from upwards of about 0.5 cm to about 0.8 cm, between 0.3 cm to about 3 cms, or more depending on the vibration frequencies to be damped and the thickness of the constraining layer.

The elastomer layer in one aspect is nano-enhanced rubber, such as a nitrile rubber. In one aspect, a useful rubber composition includes a nitrile rubber, carbon black, and optional additives such as an antioxidant, a curing agent, and/or an activator. The composite constraining layer can be suitably bonded to the elastomer layer to obtain the present acoustic and vibration attenuation composite. The use of an adhesive is not required, although, if desired, one can be used.

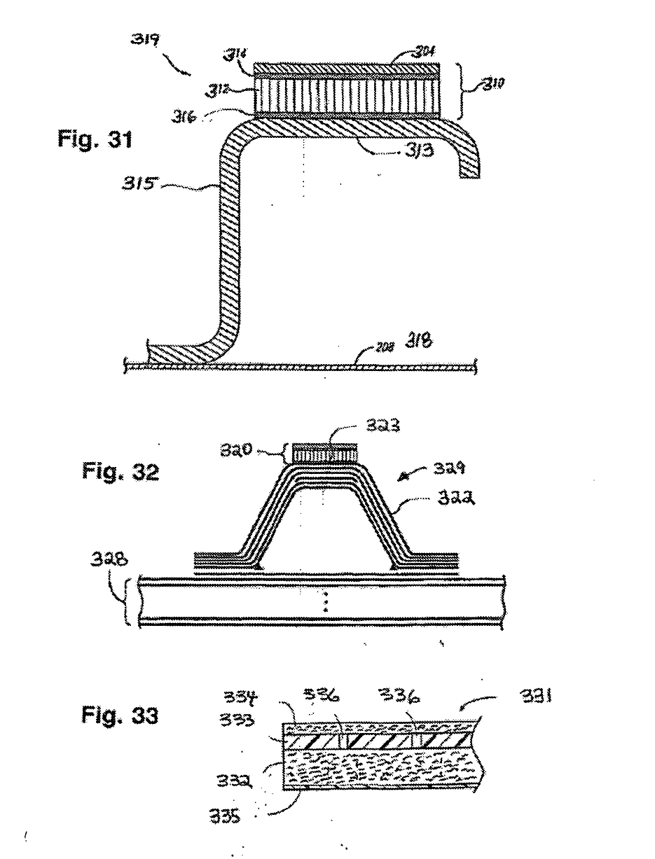

FIG. 31 is an end view of a structural assembly 319 according to the present invention that includes a constrained layer damping system 310 (“damping system 310”) configured in accordance with an embodiment of the invention. The damping system 310 is attached to a cap portion 313 of a longitudinal “Z”-section stiffener 315 (“stiffener 315”), and the stiffener 315 is attached to a member, e.g. to a skin 318. The damping system 310 includes an elastomer damping layer 314 sandwiched between an optional auxetic core 312 and a constraining layer 314. An optional adhesive layer 316 may be used. The constraining layer 314 is made entirely or partially of nano-enhanced material according to the present invention (of sufficient strength and/or hardness to withstand encountered temperatures and pressures and to sufficiently reduce vibrations. The chosen nano-enhanced elastomer material is any of sufficient strength and/or sufficient hardness according to the present invention and able to withstand encountered temperatures and pressures and to reduce vibrations. Items similar to the system 310, but with no teaching, motivation, or suggestion of using nano-enhanced elastomers for parts thereof, are disclosed in U.S. Pat. No. 8,042,768 incorporated fully herein for all purposes. The core 312 may be as disclosed in this patent and attached to the stiffener with the adhesive 316.

FIG. 32 is a partially exploded end view of a structural assembly 329 having a damping system 320 that is at least generally similar in structure and function to the damping system 310 described above with reference to FIG. 31. The damping system 320 is bonded to a cap portion 323 of a hat-section stiffener 322, and the hat-section stiffener 322 is attached to a member or skin 328. Both the hat-section stiffener 322 and the skin 328 can be manufactured from multiple plies of composite materials (e.g., graphite/epoxy materials). The nano-enhanced elastomer material of the system 320 is any of sufficient strength and/or sufficient hardness according to the present invention and able to withstand encountered temperatures and pressures and to reduce vibrations.

Referring now in detail to the FIG. 33, a damping panel constructed and manufactured in accordance with an embodiment of the invention is identified generally by the reference numeral 331. The panel 331 has a base plate layer 332 formed from any suitable material, e.g., but not limited to, metal, composite, plastic or a fiberglass reinforced plastic of any known type and which may be formed either from a laid-up or sprayed method. A damping layer 333 of a nano-enhanced elastomeric material according to the present invention, e.g. a nano-enhanced rubber, is attached with adhesive bonding to the base layer 332. Holes 336 can help facilitate spreading of the adhesive. An optional restraining layer 334 of a rigid material, e.g, a fiberglass reinforced plastic layer, is affixed by an adhesive bonding or the like to the layer 333.

In one aspect, layer 334 has a thickness that is substantially less than the thickness of the base layer 332 and which is no greater than that of the layer 333. In a specific embodiment of the invention, the layer 332 may have a thickness of 10 mm while the damping layer 333 and restraining layer 334 have thickness of 2 mm each. A gel coat layer 335 may be laminated to the outer surface of the base 332. When used in a hull construction, the gel coat 335 may face outwardly while the restraining layer 334 will face inwardly. If desired, a gel coat layer may also be laminated to the outer surface of the restraining layer 334.

Any nano-enhanced elastomer according to the present invention may be combined with a desired amount of additive or additives (any suitable known additive or additives useful as an additive for elastomers). Any nano-enhanced elastomer according to the present invention may be combined with a desired amount of any suitable known additive package used for elastomers. Any nano-enhanced elastomer according to the present invention may be combined with a desired amount of antioxidant (any suitable known antioxidant useful as an additive for elastomers). Any nano-enhanced elastomer according to the present invention may be combined with a desired amount of a stiffener (any suitable known stiffener useful as an additive for elastomers, including, but not limited to, carbon black). Any nano-enhanced elastomer according to the present invention may be combined with a desired amount of antioxidant (any suitable known antioxidant useful as an additive for elastomers) and with a desired amount of a stiffener (any suitable known stiffener useful as an additive for elastomers, including, but not limited to, carbon black).

1-30. (canceled)

31. A composite comprising elastomeric material, nanomaterial, and strengthener material, the strengthener material interacting with both the elastomeric material and the nanomaterial to enable transfer from the elastomer to the nanomaterial.

32. The composite of claim 31, wherein the transfer is at least one of or a combination of two or all three of: mechanical load transfer, thermal transfer, and electrical transfer.

33. The composite of claim 31, wherein the strengthener material is one of linking agent, surfactant, compatibilizer, and functionalized carbon nanotubes.

34. The composite of claim 31 wherein the strengthener material surfactant is a zwitterionic surfactant.

35. The composite of claim 31, wherein the elastomeric material is a matrix and the strengthener material simultaneously provides dispersion of the nanomaterial within the matrix and provides a link between the nanomaterial and the elastomeric material.

36. The composite of claim 31 wherein the elastomer has a backbone and the strengthener material has a backbone that bonds to the nanomaterial through hydrogen bonding and hydrophobic forces, and the strengthener material has a head group that bonds to the elastomer backbone through bonding that includes hydrogen bonding.

37. The composite of claim 31, wherein the strengthener material comprises functionalized carbon nanotubes and the functionalization is one of: a chemically covalent functionalization; non-covalent surfactant wrapping with a zwitterionic surfactant which simultaneously interacts with an elastomer backbone of the elastomeric material and with the nanomaterial to enable load transfer between the two materials; sidewall functionalization; and end functionalization.

38. The composite of claim 31, wherein the elastomeric material is one of or a combination of : nitrile butadiene rubber; NIPOL (trademark) material; NBR; hydrogenated butadiene nitrile rubber; ETPOL (Trademark) hydrogenated butadiene nitrile rubber; a fluoroelastomer; VITON (Trademark) fluoroelastomer; FKM (Trademark) material; elastomeric saturated rubber that not curable by sulphur vulcanization; unsaturated rubber curable by sulphur vulcanization; thermoplastic elastomer; polysulfide rubber; proteins resilin and elastin; thermoplastic elastomer (TPE); thermoplastic rubber; and dielectric elastomer.

39. The composite of claim 31, wherein the nanomaterial comprises: single-wall carbon nanotubes (SWNTs), multi-wall carbon nanotubes (MWNTs), double-wall carbon nanotubes (DWNTs), buckytubes, small-diameter carbon nanotubes, fullerene tubes, tubular fullerenes, grapheme ribbons, graphite fibrils, carbon nanofibers, purified carbon nanotubes, unpurified carbon nanotubes, raw as-produced carbon nanotubes, and combinations thereof.

40. The composite of claim 31, wherein the strengthener interacting comprises one of ionic bonding, covalent bonding, electrostatic interaction, hydrogen bonding, hydrophilic force and hydrophobic force.

41. The composite of claim 31, wherein in the combination of elastomeric material and nanomaterial, the nanomaterial is carbon nanotubes in an amount of 0.0001-90 wt.%, and wherein the strengthener material is a surfactant present in the composite in an amount ranging from 10⁻⁶ wt % to 15 wt %.

42. The composite of claim 31, including an additive wherein the additive is one of or a combination of: an elastomer additive; an elastomer additive pack; carbon black; an antioxidant; a curing agent; a plasticizer; a barrier molecule; a viscosity modifier; a lubricity modifier;
and a simple volume filler.

43. The composite of claim 42, which has about 4% carbon nanotubes by weight relative to the elastomer mass.

44. The composite of claim 31 wherein, the composite comprises an elastomer composite which forms part of a ship, boat, hull, damping panel, article, seal, gasket, tire, toy, ball, bumper, vibration mount, shock absorber, bellow, expansion joint, catheter, bearing pad, stopper, glove, balloon, tubing, conduit, pipe, casing, adhesive, footwear, grommet, bushing, bearing, clothing, fastener, connector, washer, inner tube, diaphragm, roofing material, hose, valve ball, valve seat, hydraulic cups o-ring, roller, wheel, spark plug cap, computer part, computer case, cell phone case, cell phone part, keyboards, mouse pad, electronic housing, housing, container, filter, filter media, golf ball, prosthetic, dielectric elastomer actuator, screen, shale shaker seal, shale shaker mount, shale shaker screen seal, shale shaker screen mount, top drive seal, drill bit seal, drill bit bearing, and blowout preventer seal.

45. The elastomer of claim 31 comprising an elastomer composite comprising:
100 parts per hundred;
about 40 parts per hundred total carbon black;
5 parts per hundred antioxidants; and
about 5 parts per hundred curing agent

46. A nanocomposite comprising carbon nanotubes, elastomer present in an elastomer matrix, the carbon nanotubes dispersed in the elastomer matrix, and a compatibilizing surfactant that interacts with both the carbon nanotubes and with the elastomer matrix.

47. The composite of claim 46 including an additive wherein the additive is one of or a combination of: an elastomer additive; an elastomer additive pack; carbon black; an antioxidant; a curing agent; a plasticizer; a barrier molecule; a viscosity modifier; a lubricity modifier;
and a simple volume filler.

48. The nanocomposite of claim 46 wherein the composite comprises armor and the armor is or is part of a backing, tile, laminate barrier, binder layer, panel, vest, insert, plate armor structure, or armor structure layer.

49. A method for making an elastomer composite comprising:
dispersing functionalized carbon nanotubes (small-diameter multi-walled carbon nanotubes—10-15 nanometer diameter, functionalized with fluorine) in a low viscosity solvent, e.g., acetone, and, adding, by high shear and paddle mixing, the carbon nanotubes to an elastomer/acetone matrix wherein the elastomer is HNBR, e.g., commercially available ZETPOL (Trademark) 1020 elastomer; and
drying the elastomer to less than 0.02% solvent (e.g., by heating in a vented oven, by pressing the material on a two or three roll mill, or by exposure to a stream of dry, hot gas), producing an elastomer composite.

50. The method of claim 49, wherein the elastomer composite has about 4% carbon nanotubes by weight relative to the elastomer mass.
